(19) United States
(12) Patent Application Publication
(10) Pub. No.: US 2004/0064633 A1
(43) Pub. Date: Apr. 1, 2004

(54) Method for storing data using globally distributed storage system, and program and storage medium for allowing computer to realize the method, and control apparatus in globally distributed storage system

(75) Inventor: Masao Oota, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/665,133

(22) Filed: Sep. 22, 2003

(30) Foreign Application Priority Data
Sep. 30, 2002 (JP) 2002-286528

(51) Int. Cl. G06F 13/28; G06F 13/00; G06F 12/16; G06F 12/14; G06F 12/00

(52) U.S. Cl. 711/100

(57) ABSTRACT

A control device for preparing redundant data, dividing the data into a plurality of volumes, and distributing and storing volumes in a plurality of storage units scattered through a network includes a route management unit and a storage set management unit. The route management unit computes an evaluation value indicating the preferability of a use target on each of the scattered storage unit based on the bandwidth, the communications cost, the physical distance between a node requesting a write and a storage unit. The storage set management unit selects a plurality of storage units as the optimum storage set from among the above mentioned scattered storage units based on the evaluation value.

### BACKGROUND OF THE INVENTION

1. Field of the Invention

The present invention relates to the technology of improving the redundancy of data and the performance of a storage device by multiplexing a storage device in a system, that is, the technology relating to a RAID (redundant array of inexpensive disks).

2. Description of the Related Art

Conventionally, the fault tolerance of a system can be improved by dividing a piece of data into plural pieces and distributing and storing the divided data in a plurality of storage units using the RAID. The RAID has seven levels from 0 to 6, a combination of a plurality of RAID levels, and an uncommon unique level. At the level 5 among the above mentioned levels, data is divided into plural pieces, each piece of the divided data is assigned parity data, and each piece of the divided data is distributed and stored in a plurality of storage units. It is desired that the level 5 is used between the devices close related to each other such as a network terminal or a process server, and a file server.

FIG. 1 shows a configuration of a system using the RAID. In FIG. 1, using a router R (repeater), a storage service center SC, a backup center BC, a mirror center MC, and a user (network terminal or a process server) are connected, thereby forming a globally distributed storage system.

Described below is the process performed in the globally distributed storage system based on the assumption that the user has a home office and a branch office, and a user UH of the home office stores data in the globally distributed storage system, and a user UB of the branch office uses the data.

First, the user UH of the home office stores data to be stored in a storage unit of the storage service center SC. The storage service center SC replicates the data, and stores the replicated data in the storage unit of the backup center BC. It is desired that the storage service center SC is physically distant from the backup center BC to avoid the possibility of harm from disasters, etc. to the storage service center SC and the backup center BC.

Furthermore, to improve the response when the user UB of the branch office reads data from a storage unit, the storage service center SC replicates data, and stores the replicated data in the storage unit of the mirror center MC which is the connection point nearest to the branch office, or broaden the band to be allocated to the circuit from the user UB of the branch office to the storage service center SC. The backup center BC can also be a mirror center MC.

There also is an invention as the technology relating to the RAID disclosed in the Japanese Patent Publication No. 2002-500393 for determining at random a storage unit for a striping destination which divides data into segments and scatters the segments in the respective storage units at random. According to this invention, the problem that the entire load is charged on the secondary backup storage unit when the primary storage unit becomes faulty, and the problem that there is a strong probability of a convoy effect can be solved.

As another technology relating to the RAID, there is an invention disclosed in the Japanese Patent Application Laid-open No. Hei 9-171479 for dividing data into plural pieces when data stored in a storage unit is mirrored, and distributing and storing the divided data in a plurality of storage units. According to this invention, although the original storage unit becomes faulty, the data distributed and stored in the plurality of storage units can be read, and using the data the data stored in the original storage unit can be reconstituted.

As a further technology relating to the RAID, there is an invention disclosed in the Japanese Patent Application Laid-open No. Hei 10-333836 for transmitting data stored in a buffer, written to a storage unit, and transmitted in a composite packet when there are plural pieces of data to be transmitted to the same storage unit. According to this invention, the I/O throughput of the RAID can be improved.

However, there has been the following problem with the conventional globally distributed storage system shown in FIG. 1.

1) Since it is necessary to provide a storage unit for a backup center and/or a mirror center having a storage unit of the same capacity as the storage service center, the system is costly.

2) When backup or mirroring is performed, a line is used inefficiently for the process.

3) Although the network terminal or the process server used by the user is used in a multi-homing system, a plurality of lines available in the system cannot be efficiently used.

4) When a storage unit, etc. in a storage service center SC, a backup center BC, or a mirror center MC is stolen, the data stored in the storage unit is subject to damage, it is poor in security. Furthermore, in the above mentioned three inventions, the above mentioned problems 1) through 4) have not been solved yet.

### SUMMARY OF THE INVENTION

The present invention has been developed to solve the above mentioned problems, and aims at providing a RAID in which a storage capacity required for a redundancy of data can be smaller, the security of data can be improved, and lines can be efficiently used.

To attain this, according to the first aspect of the present invention, a method of a computer preparing redundant data, dividing the data into a plurality of volumes, and distributing and storing each volume in a plurality of storage units scattered through a network includes the steps of: computing an evaluation value indicating the preferability of a use target on each of the scattered storage unit based on the bandwidth, the communications cost, the physical distance between a node requesting a write and a storage unit; and selecting a plurality of storage units as the optimum storage set from among the above mentioned scattered storage units based on the evaluation value.

It is also possible to improve the circuit efficiency and the safety of data in disaster situations by improving the data security by dividing data into a plurality of volumes and distributing and storing the divided data in a plurality of storage units, and by selecting the optimum storage unit for a node requesting a write based on the bandwidth, the communications cost, and the physical distance between the node and the storage unit.

When the evaluation value is computed in the above mentioned method, the hop count from the node requesting the write to each storage unit can also be considered because the circuit efficiency is reduced when the hop count is high.

Also the above mentioned method, may further comprise the step of providing the storage set for a user of the system as a virtual storage unit. With the configuration, the user can be free of a complicated operation in distributing and storing data.

Furthermore the above mentioned method may further comprise the steps of: when the data is read from the storage set, reading volumes which do not contain a redundant portion in the plurality of volumes written to the storage set from each storage unit; and reconstituting the data using the read volumes. With the configuration, the circuit bands to be used can be appropriately reduced.

The above mentioned method may further comprise the steps of: when the data is read, computing a use priority indicating the response based on the bandwidth and the cost; and determining which volumes in the plurality of volumes to be read from each storage unit as volumes containing no redundant portion based on the use priority. For example, when data is divided into four volumes with the redundancy of three pieces of data plus(+) one parity bit, the three volumes can be arbitrarily selected as volumes not containing a redundant portion. During the selection, the use efficiency of a circuit can be improved by considering the bandwidth and the cost.

The above mentioned method can also include the step of storing a replica of a first volume in the plurality of volumes in a storage unit not selected as a unit in the storage set. The replica can be used as backup data. Conventionally, since a replica of data has been provided as backup data, a capacity for double the original data has been required for the backup. However, in this aspect of the present invention, the storage capacity required for the backup is the capacity for, at most, one volume. Therefore, the use efficiency of a storage unit can be successfully improved.

The above mentioned method may further comprise the stop of, when a replica of the first volume is generated, selecting one of the two generating methods, that is, copying the first volume from a storage unit storing the first volume, and reproducing the first volume using the redundancy from the volumes other than the first volume in the plurality of volumes. In selecting the method, the evaluation value can be taken into account.

In the above mentioned method, a volume can be written to a plurality of storage units for storing the same volume in the multicast system. In this method, a plurality of packets having the same contents can be transmitted a plurality of times.

Additionally, in the above mentioned method, a writing process can be performed plural times when a replica of the first volume is written to a storage unit. By performing the writing process in a dividing manner, a load on a circuit at a time can be reduced by performing the process a plurality of times.

The above mentioned method may further comprise, when the first storage unit in the storage set becomes faulty, limiting a write to another storage unit in the storage set. For example, before the first storage unit recover from the fault, a volume in another storage unit can be updated. In this case, the possibility that there are different versions of volumes in the system after the recovery of the faulty storage unit can be avoided.

Also in the above mentioned method, when the third storage unit becomes faulty in the above mentioned storage set, the fourth storage unit other than the storage unit selected as a unit in the storage set can be selected instead of the third storage unit, thereby selecting the optimum storage unit replacing the faulty storage unit.

Furthermore, the above mentioned method may further comprise, if a storage set is reselected in each node at a predetermined timing after selecting the storage set, and there is a volume not used by any nodes as a result of the reselection, deleting the volume from the storage set. A predetermined timing refers to each time after the passage of a predetermined period from the previous selection or each time the state of a volume is changed. When the use state of the system is changed, an unnecessary volume is deleted depending on the use state of a volume, thereby improving the use efficiency of the storage units.

The above mentioned method may further comprise, temporarily storing in an arbitrary storage unit for a predetermined period after reading the data, when the data is read in the predetermined period, reading the temporarily stored data from the above mentioned storage unit. With the caching capability, the data read response can be improved.

Additionally, the above mentioned method may further comprise, storing the data requested to be written within a predetermined period in a temporary storage area, retrieving the data from the temporary storage area after the predetermined period, dividing the data into a plurality of volumes, and writing the plurality of volumes to the storage set. With the method, the frequency at which volumes are transferred from a node issuing a write request to other storage units can be reduced, thereby improving the efficiency of the traffic.

Also the above mentioned method may further comprise, when the plurality of volumes are written, prohibiting, by the node requesting a write, a writing process to the plurality of storage units until the write is completed. If there are a plurality of storage units for storing the same volume, then one storage unit can be determined as a representative storage unit in the storage units, the prohibition of a write to the representative storage unit can be performed by the node requesting the write, and the prohibition of a write to a storage unit other than the representative storage unit can be performed by the representative storage unit when the writing process is prohibited on the plurality of storage units. The representative storage unit can be a storage unit for storing an original volume.

A computer program used to direct a computer to perform control including the procedures included in the above mentioned method can also solve the above mentioned problems because the operations and the effects of the above mentioned method can be obtained by allowing the computer to execute the above mentioned computer program.

Furthermore, the above mentioned problems can also be solved by allowing a computer to read the above mentioned computer program from a computer-readable storage medium storing the computer program.

In addition, the operations and the effects of the above mentioned data storing method can also be obtained by a control device for performing the processes similar to the procedures in the above mentioned data storing method and controlling data to be distributed and stored in the system including storage units scattered through a network, thereby successfully solving the above mentioned problems.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 shows the configuration of a globally distributed storage system according to the related art;

FIG. 2 shows the configuration of a globally distributed storage system;

FIG. 3 shows the configuration of a control device;

FIG. 4 shows the detailed configuration of the control device;

FIG. 5 shows an example of a configuration of a practical globally distributed storage system;

FIG. 6 shows an example of a route evaluation table;

FIG. 7 shows an example of a storage evaluation table;

FIG. 8 shows an example of a storage set management table;

FIG. 9 shows an example of an access management table;

FIG. 10 shows an example of a local volume management table;

FIG. 11 shows a flow of data in the globally distributed storage system;

FIG. 12 is a flowchart of the computing process on the use priority and the evaluation value;

FIG. 13A shows an example of a route evaluation table referred to when a storage unit from which a volume is to be read is determined when data is reconstituted;

FIG. 13B shows an example of a storage evaluation table to be referred to then;

FIG. 14 is a flowchart of an updating process of a storage set management table;

FIG. 15A shows an example of a route evaluation table referred to when a method of determining a storage unit to which redundancy data is to be distributed and written;

FIG. 15B shows an example of a storage evaluation table to be referred to then;

FIG. 16 is a flowchart of the user adding process to a node;

FIG. 17 shows a method of determining a storage unit storing a replica of redundant data;

FIG. 18 shows the process of selecting the optimum storage set from among a plurality of available storage units;

FIG. 19 is a flowchart (1) of the locking process;

FIG. 20 is a flowchart (2) of the locking process;

FIG. 21 is a flowchart (1) of the writing process;

FIG. 22 is a flowchart (2) of the writing process;

FIG. 23A shows an example of an access management table referred to when a locking process is performed for updating data in a storage unit;

FIG. 23B shows an example of a local volume management table referred to then;

FIG. 24 is a flowchart (1) of the writing process performed using a multicast packet;

FIG. 25 is a flowchart (2) of the writing process performed using a multicast packet;

FIG. 26 is a flowchart (3) of the writing process performed using a multicast packet;

FIG. 27 shows the process of selecting a method of generating a replica of a volume;

FIG. 28A shows a storage unit selected before a part of storage units become faulty;

FIG. 28B shows the optimum storage unit selected from among remaining storage units after the fault occurs;

FIG. 29 shows the process of selecting a method of generating a replica of a volume when the storage unit recovers from the fault;

FIG. 30A shows a storage unit selected before an unnecessary volume is deleted;

FIG. 30B shows a storage unit selected after an unnecessary volume is deleted;

FIG. 31 is a flowchart of the process of sequentially writing or regenerating data;

FIG. 32 shows the process performed when data is sequentially replicated or regenerated; and

FIG. 33 shows a case in which a user terminal is provided with the functions of a control device.

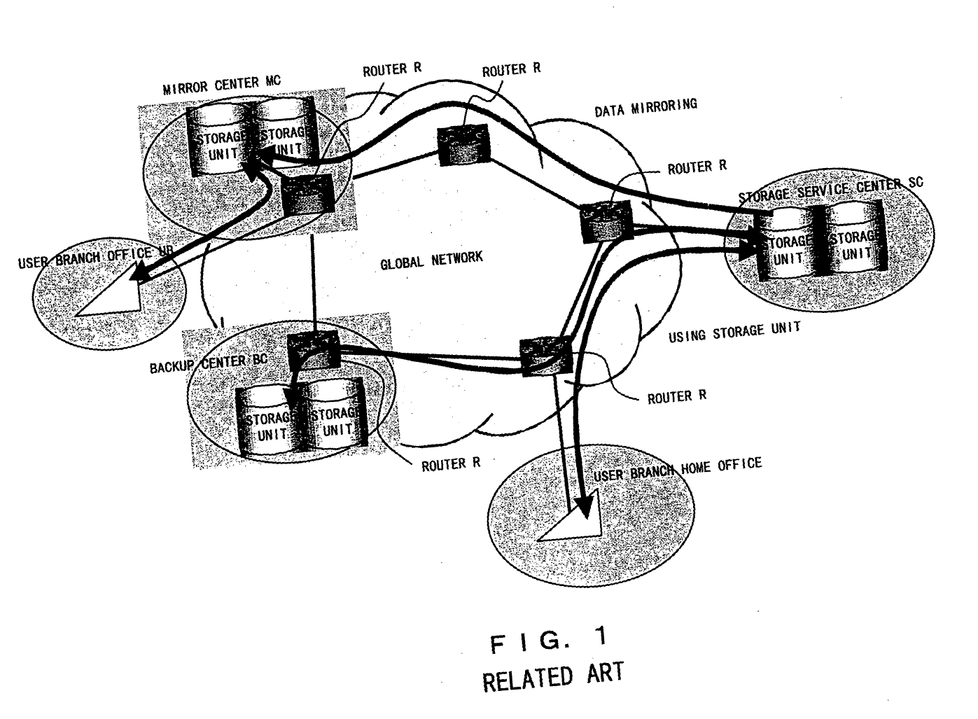

### DESCRIPTIONS OF THE PREFERRED EMBODIMENTS

The embodiments of the present invention are described below by referring to the attached drawings. The same devices, etc. are assigned the same reference numbers and the overlapping explanation is omitted. In the following explanation, a “storage unit provided for a node” can be represented by a “node” because a long sentence can complicate the entire meaning of the sentence. For example, the representation of “storing a volume in a node” practically means “storing a volume in a storage unit provided for a node”.

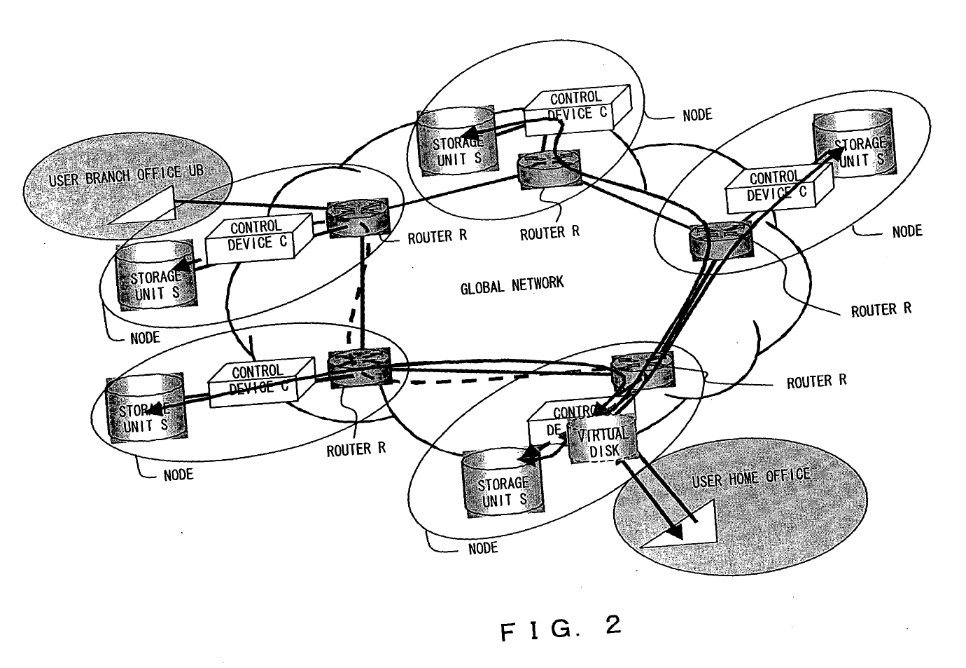

The present invention is based on the technology of adding parity to data, and distributing and storing the data and the parity in a plurality of storage units, for example, the technology such as the RAID 5, etc. FIG. 2 shows the configuration of the globally distributed storage system relating to each of the embodiments of the present invention. As shown in FIG. 2, a plurality of nodes are connected through a network in the globally distributed storage system. The data communicated among the nodes are passed by a router R. Each node is provided with a storage unit 1 and a control device C.

A user of a terminal provided for the home office of the user, a branch office of the user, etc. accesses the globally distributed storage system, stores data in the storage unit S, reads the data from the storage unit S, etc.

When an instruction is issued from a terminal to store data in a storage unit, the control device C adds ECC (error check and correct)/parity to each data block (a unit of read/write) of data to be stored, and distributes and stores the data in a plurality of storage units S. Hereinafter, the data divided and assigned parity is referred to as a volume.

When an instruction is issued from a terminal to read data stored in a storage unit, the control device C reads the data distributed and stored in the plurality of storage units S, that is, reads the volumes, reconstitutes the data, and transmits the result to the terminal.

When the data is stored and read, the control device C distributes and stores the data, and then reconstitutes the data. Therefore, the user of the terminal can store the data on one virtual disk without consideration of the distribution of the data, and can distribute, store, and reconstitute the data just as reading the data from the virtual disk.

Additionally, when volumes are read and the data is reconstituted, the control device C reads all volumes configuring the data from a plurality of storage units, and reconstitutes the data. Otherwise, the control device C can read the volumes excluding the volume of redundant data from a plurality of storage units 1 to reconstitute the data. In this case, the load on the network can be reduced. To be more practical, when the data divided into three volumes using redundant two pieces of data+one parity bit is reconstituted, the control device C reads two volumes out of three volumes, and then reconstitutes the data.

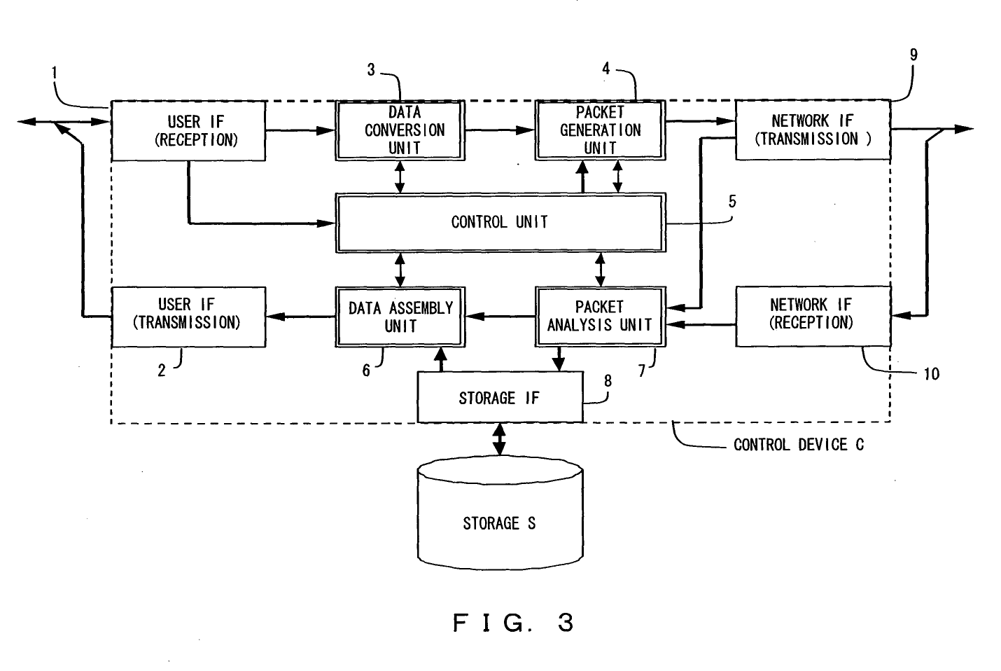

FIG. 3 shows the configuration of the control device C. As shown in FIG. 3, the control device C comprises a user interface (hereinafter referred to as a user IF) (reception side) 1, a user IF (transmission side) 2, a data conversion unit 3, a packet generation unit 4, a control unit 5, a data assembly unit 6, a packet analysis unit 7, a storage interface (hereinafter referred to as a storage IF) 8, a network interface (hereinafter referred to as a network IF) (transmission side) 9, and a network IF (reception side) 10.

The user IF (reception side) 1 receives a packet for access to the storage unit 1 from the user, and allots the control information to the control unit 5 and the data to the data conversion unit 3.

The data conversion unit 3 divides data into data blocks, and adds parity to each block.

The packet generation unit 4 assembles data divided in a block unit or control information in a packet for transmission to a global network.

The network IF (transmission side) 9 transmits a packet generated by the packet generation unit 4 to the network.

The network IF (reception side) 10 receives data or control information from a global network.

The packet analysis unit 7 analyzes a packet output from the network IF (reception side) 10, reads data from a storage unit S, or writes data to a storage unit S.

The data assembly unit 6 assembles the signals read from the storage unit S, and generates an appropriate packet including control information in response to a data access instruction from a user.

The control unit 5 manages a storage unit S and data and processes a packet to be transmitted or received in response to access by a user.

The user IF (transmission side) 2 transmits a packet assembled by the data assembly unit 6 to a user.

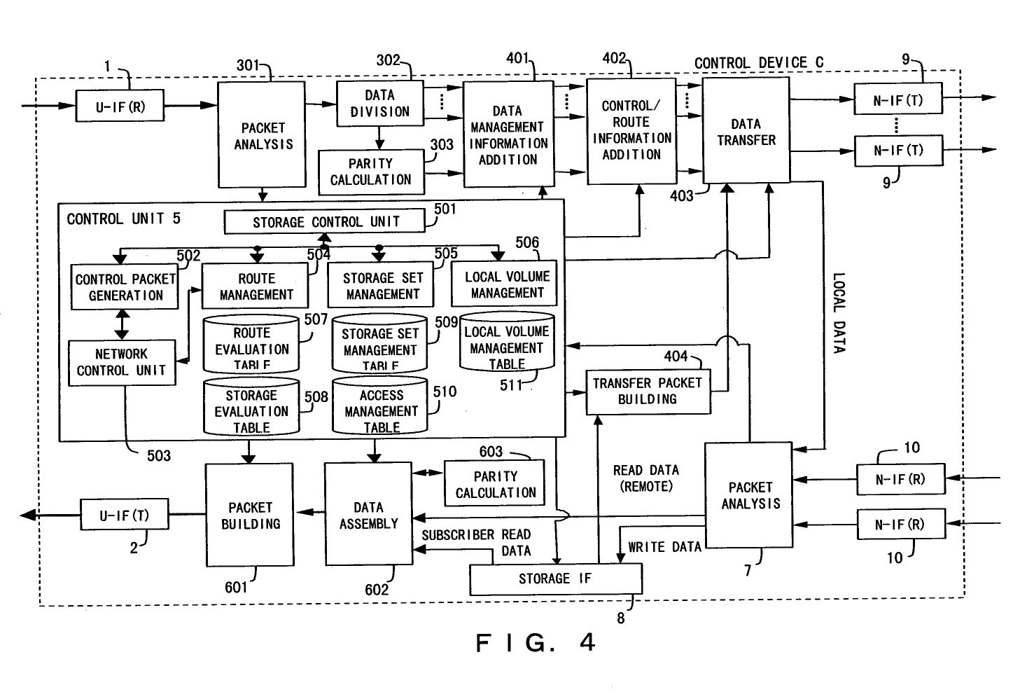

FIG. 4 shows the detailed configuration of a control device C. The operations of the data conversion unit 3, the packet generation unit 4, the control unit 5, and the data assembly unit 6 are described below in detail by referring to the detailed configuration shown in FIG. 4.

The data conversion unit 3 comprises a packet analysis unit 301, a data division unit 302, and a parity calculation unit 303. The packet analysis unit 301 analyzes a received packet, and obtains data from the packet. The data division unit 302 divides the data into data blocks. The parity calculation unit 303 calculates the parity and adds the result to the data block.

The packet generation unit 4 comprises a data management information addition unit 401, a control/route information addition unit 402, a data transfer unit 403, and a transfer packet building unit 404. The data management information addition unit 401 adds data management information output from the control unit 5 to the data block. The data management information can be storage set configuration information (described later), etc., and depends on the contents of the process performed based on the packet. The data management information transmitted in each process is described later.

The control/route information addition unit 402 adds control information and route information to a data block. The route information is information about the route to a destination node of the data block, and the evaluation value of the route, and generated by the control unit 5. The control information is information about the contents of the control, for example, a data write, a data read, the control of a write to a storage unit, etc., and is generated by the control unit 5.

The data transfer unit 403 transfers a data packet provided with the data management information and control/route information, or a control packet output from the control unit 5. When it is transferred, the data transfer unit 403 adds to the packet the address of the node, which is the destination of the packet, for example, an IP (Internet protocol) address, etc. The address is output from the control unit 5. When it is determined according to the control/route information that the data is local data to be written to a storage unit in the node, the data transfer unit 403 outputs the data to the packet analysis unit 7.

The transfer packet building unit 404 assembles the data read from the storage unit S through the storage IF 8 into a transfer packet for transfer to the control device C of another node, and outputs it to the data transfer unit 403. When the packet is built, the transfer packet building unit 404 performs processes similar to those of the data management information addition unit 401 and the control/route information addition unit 402.

The control unit 5 comprises a storage control unit 501, a control packet generation unit 502, a network control unit 503, a route management unit 504, a storage set management unit 505, a local volume management unit 506, a route evaluation table 507, a storage evaluation table 508, a storage set management table 509, an access management table 510, and a local volume management table 511. The storage control unit 501 controls a data write, read, lock, etc. to a storage unit S according to the control information output from the packet analysis unit 301. The storage control unit 501 also controls the cooperative operations among the control packet generation unit 502, the network control unit 503, the route management unit 504, the storage set management unit 505, and the local volume management unit 506.

The control packet generation unit 502 generates a control packet indicating the contents of the control such as a data write, a data read, a lock to a storage unit S, etc. The control packet is transmitted to another storage unit. The network control unit 503 generates the route information about the node which is the destination of a packet, the address of the node, etc. based on the output from the route management unit 504. The address of the node is assumed to be recorded on an address table not shown in the attached drawings. The address table is obvious, and is not explained here.

The route management unit 504 determines the destination of the data divided into blocks, that is, the data storage desination, the data transfer destination, etc. according to the information stored in the route evaluation table 507 and the storage evaluation table 508. The storage set management unit 505 manages a plurality of volumes configuring data using the storage set management table 509. The storage set management unit 505 also manages the access to each storage unit using the access management table 510 when a volume stored in a storage unit S of each node is updated. The local volume management unit 506 manages the use state of a local storage unit using the local volume management table 511. The structure of each table is described later in detail.

The data assembly unit 6 comprises a packet building unit 601, a data assembly unit 602, and a parity calculation unit 603. The parity calculation unit 603 computes the parity. The data assembly unit 6 reconstitutes the data before the division based on the parity and the volume number indicating the volume to which the data belongs using the data of a volume (volume data) read from a local storage unit S and the volume data in the packet received from another node. The volume number is assigned to volume data. The packet building unit 601 generates a packet to transmit the reconstituted data to a user who has issued a data access instruction.

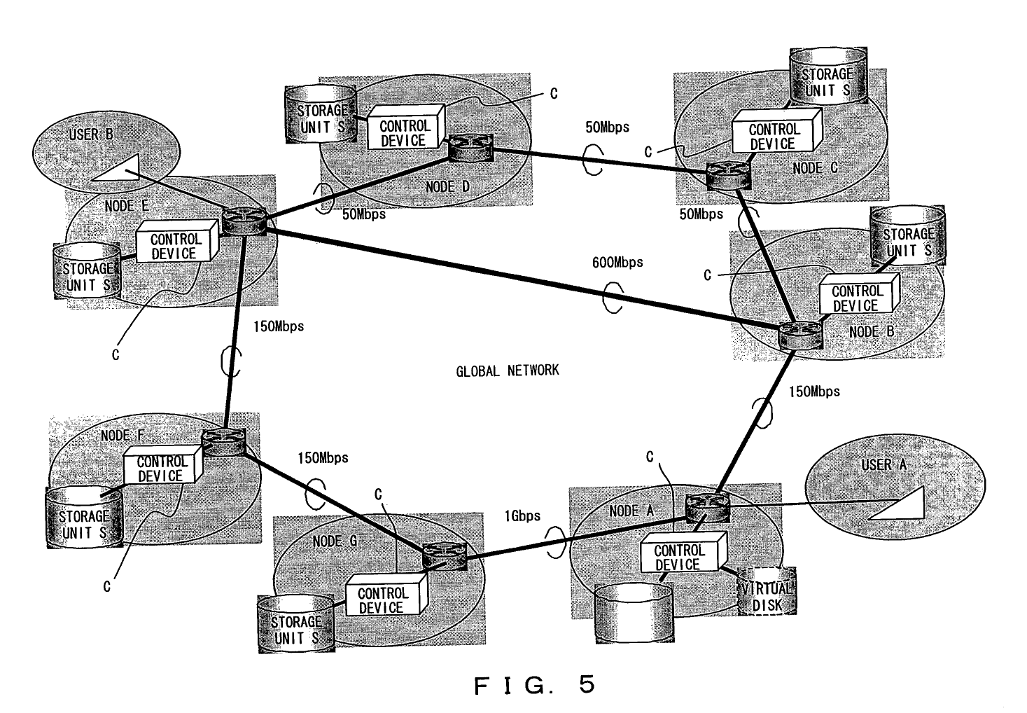

FIG. 5 shows an example of a practical configuration of the globally distributed storage system. The configuration of each table, the operation of a control device, etc. are described below by referring to the practical configuration shown in FIG. 5, but the configuration shown in FIG. 5 is assumed for practical explanation. Therefore, it is obvious that the present invention is not limited to this configuration.

As shown in FIG. 5, the nodes are connected from node A to node G through the global network. Each node is provided with a control device C and a storage unit S. The bandwidths between the node A and the node B (hereinafter referred to as a section A-B), between the node E and the node F (hereinafter referred to as a section E-F), and between the node F and the node G (hereinafter referred to as a section F-G) are 150 Mbps. The bandwidths between the node B and the node C (hereinafter referred to as a section B-C), between the node C and the node D (hereinafter referred to as a section C-D), and between the node D and the node E (hereinafter referred to as a section D-E) are 50 Mbps. The bandwidth between the node G and the node A (hereinafter referred to as a section GA) is 1 Gbps. The bandwidth between the node B and the node E (hereinafter referred to as a section BE) is 600 Mbps.

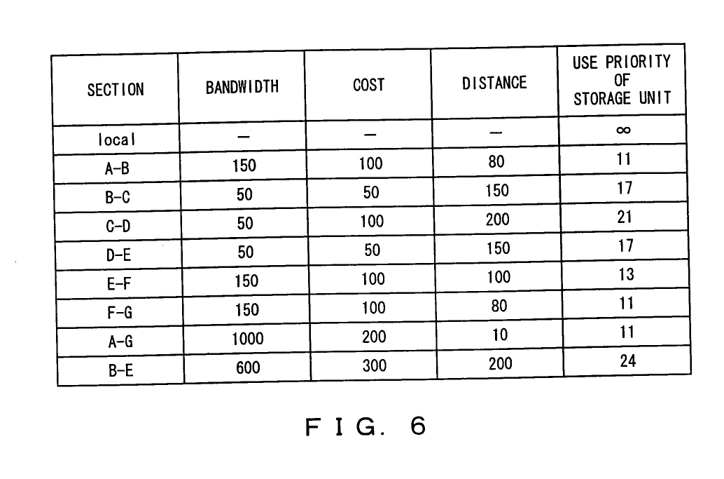

The structure of a table provided for a control device C is described below by referring to FIGS. 6 through 9. First, the structure of the route evaluation table 507 is described below by referring to FIG. 6. The route evaluation table 507 stores the route evaluation information about each node configuring the globally distributed storage system. The route evaluation table 507 is referred to when the superiority of a route connecting each node is evaluated. As shown in FIG. 6, the route evaluation information includes the code for identification of a section, the bandwidth of the section, the communications cost for the section, the physical distance of the section, the use priority of a storage unit, etc. as items. The route evaluation information can further include the use priority of a section. Since it is not necessary to communicate via a network with a local node, that is, a node to which the control device C provided with the route evaluation table 507 belongs, the bandwidth, the cost, and the distance are empty.

The bandwidth, the communications cost, and the physical distance are determined based on the configuration of the globally distributed storage system, and is basically the same for a control device of any node. The use priority of a storage unit and the use priority of a section are represented by values computed by each control device C. The use priority is determined by a distance for evaluation of the safety of the data backup in case of a disaster, etc. in addition to the bandwidth and the cost.

The equation of the storage use priority is represented as follows

storage use priority=(bandwidth×A) ÷(cost×B)+(distance×C)

The A, B, and C are weight constants. In the description below, for example, A, B, and C are assumed to be 2, 1, and 0.1 respectively. Each weight constant can be changed with the capability to be prioritized, that is, the communication speed, the cost, etc. taken into account.

FIG. 6 shows the route evaluation table 507 relating to the node A of the system shown in FIG. 5. The storage use priority of the section A-B is practically computed as follows.

storage use priority of section A-B=(150×2)÷(100×1)+(80×0.1)=11

Therefore, the route evaluation table 507 shown in FIG. 5 stores “11” as the storage use priority of the section A-B.

The use priority of a section is represented by a value obtained by normalizing bandwidth÷cost.

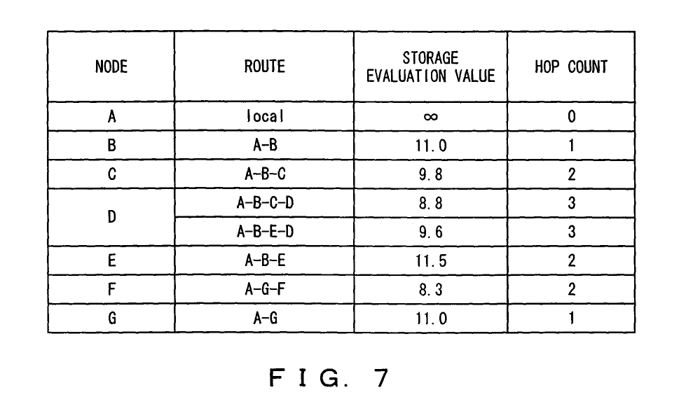

The structure of the storage evaluation table 508 is described below by referring to FIG. 7. The storage evaluation table 508 stores the storage evaluation information about a storage unit provided for each node configuring the globally distributed storage system. The storage evaluation table 508 is referred to when a storage unit of which node is determined when a storage set is generated, added, etc. As shown in FIG. 7, the storage evaluation information includes the code for identification of a node, the route from a local node to the node, a storage evaluation value, a hop count, etc. as items. A local node refers to a node of the control device C provided with the storage evaluation table 508. A hop count refers to the number of nodes existing on the route to a specific node. A storage evaluation value is computed by the control device C and the equation is represented below.

$$\begin{matrix}storage evaluation value = \\ \sum \{ ( storage use priority of node on route ) \times \\ ( weight constant ) \} / \\ ( hop count to last node of route )\end{matrix}$$

where if the weight constant is an inverse of the hop count, then the equation of the storage evaluation value is represented as follows.

$$\begin{matrix}storage evaluation value = \\ \sum \{ ( storage use priority of node on route ) \div \\ ( hop count to the node ) \} / \\ ( hop count to last node of route )\end{matrix}$$

FIG. 7 shows the storage evaluation table 508 provided for the node A in the system shown in FIG. 7. For example, the storage evaluation value of the node B and the storage evaluation value of the node C from the node A are practically computed as follows.

$$\begin{matrix}storage evaluation value of node B = \\ ( storage use priority of section A \text{-} B \div 1 / 1 ) / 1 = 11 \\ storage evaluation value of node C = \\ ( storage use priority of section A \text{-} B \div 1 ) + \\ ( storage use priority of section B \text{-} C \div 2 ) \} / 2 = \\ \{ 11 \div 1 + 17 \div 2 \} / 2 = 9.75\end{matrix}$$

The storage evaluation information can also include a route evaluation value as an item. The route evaluation value is computes by dividing the sum of the use priorities of the sections to the last node by the hop count.

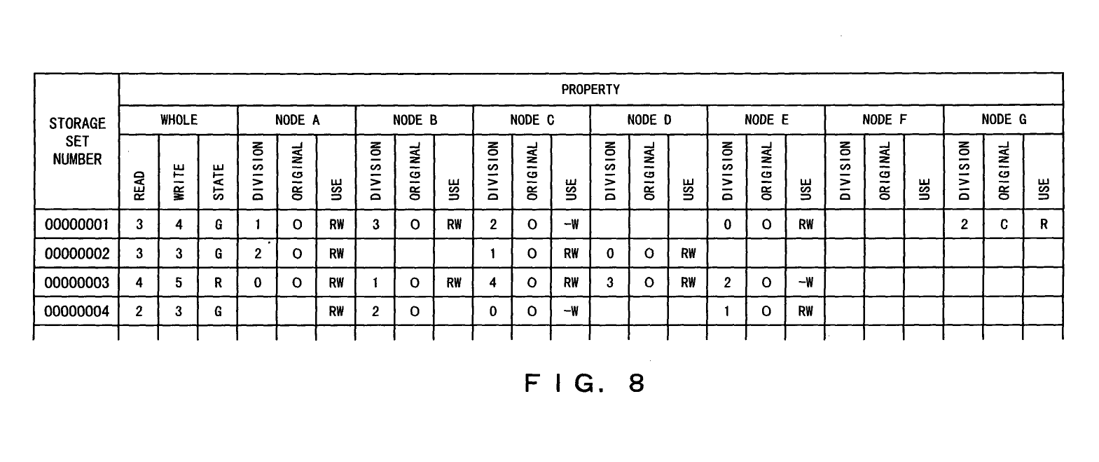

Then, by referring to FIG. 8, the structure of the storage set management table 509 is described below. The storage set management table 509 is a table for management of the information about each storage set. The storage set management table 509 stores storage set configuration information. The storage set configuration information includes a storage set number for identification of a storage set, the information about the storage set corresponding to the number, that is, the property.

A storage set is a plurality of storages each of which distributes and stores volume obtained by dividing data, in view of the whole system. However, as described later, in each node, all storage units storing distributed volumes are not usually used (for a write, a read, etc.), but at least a part of the storage units are used. Storage units used in each node are managed according to the use state information included in the property described later. Those other than used storage units function as backup units, etc. Therefore, from each node, a storage set refers to storage units permitted to be used according to the use state information.

A storage set number is used for identification of a storage set, but can also be used as the information for identification of data. For example, a user of a system uses a storage set number for designation of data to be read because a storage set is provided as a virtual storage unit for a user.

Property can be used for either the entire globally distributed storage system or each node. The property for the entire system includes the information about the number of nodes in which data is divided and the state (normal or abnormal) of a storage unit in each node. The number of nodes in which data is divided is stored respectively for a read and a write. In FIG. 8, when “G” is stored as the state of a storage unit, the state is “normal. When “R” is stored, the state is “abnormal”.

The property for a node includes use state information about a volume number indicating which volume in the storage set is stored by the storage unit of the node, a flag indicating whether or not the volume is original data, a use state such as a read enable state, a write enable, etc. of each node from a local node. The information in the storage set management table 509 is exchanged among the control devices C in the nodes. If the flag indicating whether the volume is original data or a replica is set to “0”, then the volume is original data. If it is “C”, then the volume is a replica. In the sequential storage described later, an incomplete volume being stored can be stored in the storage unit S. A flag indicating incomplete data can be represented by, for example, “Q” to be distinguished from “O” and “C”.

For example, the storage set structure information having the storage set number of “00000001” shown in FIG. 8 is described below. Since “3” is stored as the number of read nodes of the entire property of the storage set structure information, three volumes are required to reconstitute the data. Similarly, since “4” is stored as the number of write nodes, the data is divided into four volumes and stored. With the storage set structure information, the property of the nodes A, B, C, E, and G is written. Therefore, these nodes store volumes. For example, according to the property of the node A, the node A stores the volume having the volume number of “1” indicating the original data in the read and write enabled state.

The use state information in the storage set structure information indicates the storage unit S normally used in the node provided with the storage set management table 509, that is, the storage set viewed from the node. In the present embodiment, a storage set viewed from a local node is assumed to have the use state information of “RW”, that is, a plurality of storage units which are read enabled and write enabled. FIG. 8 shows the storage set management table 509 as an example provided for the node A. In FIG. 8, relating to the data having the storage set number of “00000001”, the storage set viewed from the node A is storage units S provided for the nodes A, B, and E.

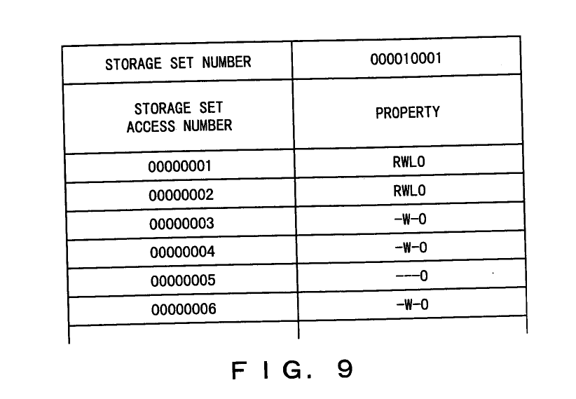

The data structure of the access management table 510 is described below by referring to FIG. 9. The access management table 510 stores access management information for each accessing operation. The control device C controls the access to a storage unit S in each node from a user. The access from the users sharing the same storage set is controlled according to the same information. The access management information includes a storage set access number and the property in an access unit as items. A storage set access number refers to a number indicating a logical access unit (logical block) to a storage set. The property refers to the state of a logical block indicated by the storage set access number, for example, a read enabled state, a write enabled state, a locked state, complete data, generated data, etc. In FIG. 9, the read enable state is represented by “R”, the write enabled state is represented by “W”, the locked state is represented by “L”, and the original data is represented by “O”. The locked state refers to a write restricted state. For example, when data in a storage unit is updated, etc., the state is set by the control device C (described later). FIG. 9 shows, for example, an access management table for a storage set having the storage set number of “000010001”. Complete data refers to a data reconstituted from a volume read from a storage unit. Generated data refers to a data generated using the redundancy in a state in which a part of volumes is insufficient.

The access management information can also include a lock key as an item. A lock key refers to the information for identification of a user requesting update of data identified by a storage set number, and is generated by the control device C which receives an update request.

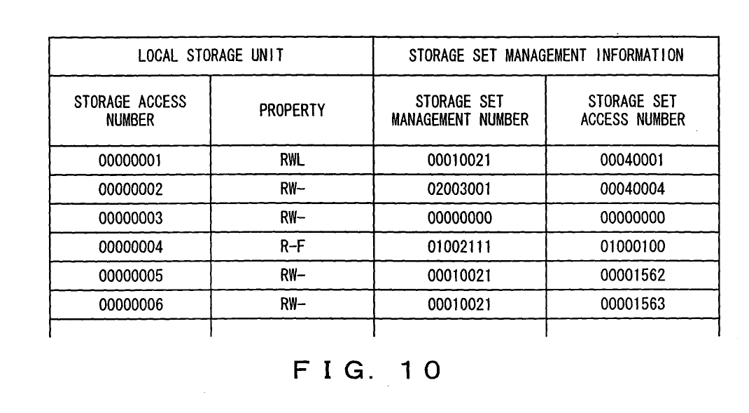

The data structure of the local volume management table 511 is described below by referring to FIG. 10. The local volume management table 511 manages the use state of a volume stored in a storage unit S connected to the control device C provided with the table, that is, a local storage unit. The local volume management table 511 individually exists in the control device C of each node.

The local volume management table 511 stores volume management information for each accessing operation to a local storage unit. As shown in FIG. 10, the volume management information includes a storage access number indicating the access unit to a local storage unit, the property indicating the state of the logical block indicated by the storage access number, a storage set number for identification of a storage set, and a storage set access number corresponding to the storage access number as items.

Described below are the operations in the globally distributed storage system. In the following explanation, data is divided into three volumes each having a redundant configuration of two pieces of data+1 parity bit, and is assumed to be distributed and stored in the globally distributed storage system. However, the explanation is given for comprehensibility, but not for limit of the redundant configuration of data.

The user of a global distribution system normally accesses the global distribution system through the closest node in the network.

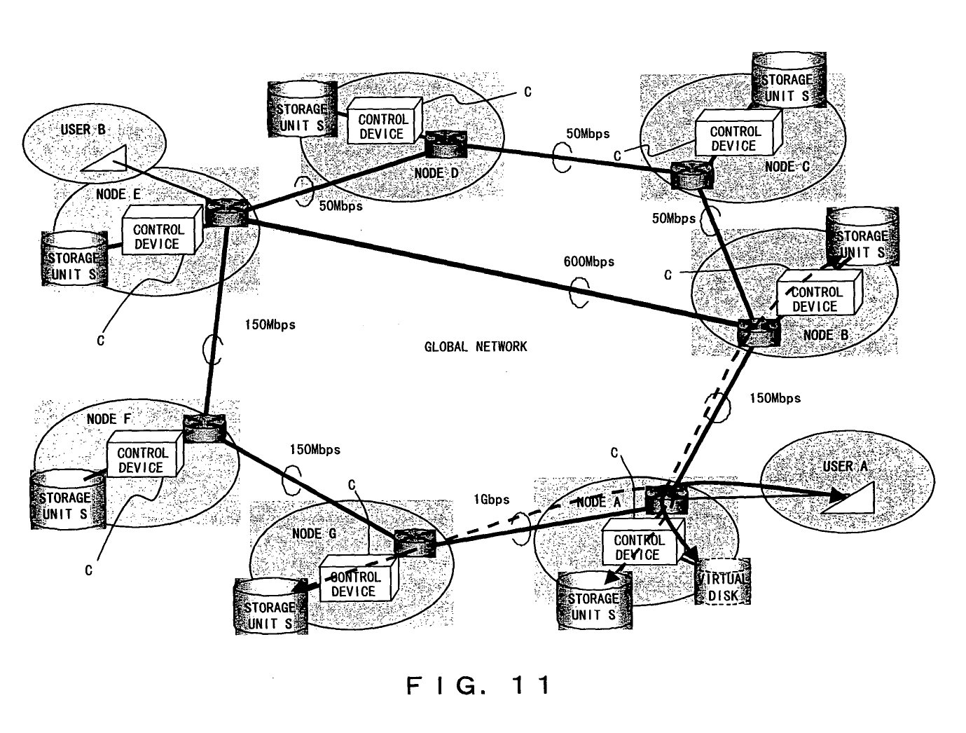

The flow of data when the user A accesses the global distribution system through the node A is described below by referring to FIG. 11. In FIG. 11, the arrow represented by solid lines indicates the flow of data viewed by the user, and the arrow represented by broken lines indicates the actual flow of data. It is assumed that the user A accesses the global distribution system through the node A, and issues an instruction to store data.

From the user A, the data seems to have been stored in a virtual disk in the node A. However, the control device C of the node A actually divides the data into a plurality of volumes with parity assigned, and distributes and writes the volumes in the storage units S provided in a plurality of nodes configuring the global distribution system. In the case shown in FIG. 11, the control device C of the node A divides the data into three volumes, and writes the volumes respectively to the storage unit S (A) in the node A, the storage unit S (B) in the node B, and the storage unit S (G) in the node G.

The operations of the control device C when the data is written are described below in more detail.

1) The packet analysis unit 301 of the control device C analyzes a received packet, and obtains the control information about a write instruction and the data from the packet.

2) The data division unit 302 divides the data into data blocks.

3) The parity calculation unit 303 computes the parity and adds it to the data blocks.

4) The route management unit 504 equally divides data by dividing a data block into three volumes, and determines the three nodes in an optional method as a storage set for distributing and storing the respective volumes. In this explanation, the nodes A, B, and G are determined as a storage set.

5) The storage set management unit 505 generates storage set configuration information based on the determination result of the storage set, and writes the information to the storage set management table 509.

6) The control packet generation unit 502 generates a control packet instructing data write control. The network control unit 503 generates the route information about the nodes A, B, and G which are the destinations of the packets, the node addresses, etc. based on the output from the route management unit 504.

7) The data management information addition unit 401 adds the storage set configuration information to the data block of three volumes. The control/route information addition unit 402 adds the control information for an instruction of write control, and the route information to the data block. The data transfer unit 403 transfers a control packet output from the control unit 5.

If it is determined according to the control/route information that the data is to be written to a local storage unit (local data) to a storage unit S (A) in the node A, then the data transfer unit 403 outputs the data to the packet analysis unit 7.

8) The packet analysis unit 7 controls a write of one of the plurality of volumes to a local storage unit S (A). After a write, the local volume management unit 506 generates volume management information, and stores it in the local volume management table 511. In the values contained in the volume management information, the property and a storage set number are obtained by reading them from a packet.

9) The transferred volume is written by the packet analysis unit 7 of the node at each transfer destination to a storage unit S of the node. The volume management unit 506 of the node for storing the volume generates the volume management information as described above, and stores the information in the local volume management table 511.

On the other hand, when the user A reads the distributed and stored data, it seems to the user A that the data has been read from one virtual disk provided in the node A. However, the control device C of the node A actually reads three volumes from a plurality of nodes, and reconstitutes data. Described below in detail are the operations of the control device C when it reads data.

1) The packet analysis unit 301 of the control device C analyzes a received packet, and retrieves control information indicating a read instruction from the packet.

2) The storage set management unit 505 obtains the storage set configuration information about the data indicated by the read instruction from the storage set management table 509, and obtains the node names of each node in the storage set viewed from the node accessed by the user A. In the present case, they are the nodes A, B, and G.

3) The data assembly unit 602 of the node A obtains a volume from a local storage unit S.

4) To obtain the remaining two volumes stored in the nodes B and G, the control packet generation unit 502 generates a control packet indicating data read control. The network control unit 503 generates the route information about the nodes B and G which are the destinations of the packet, and the addresses, etc. of the nodes.

5) The data management information addition unit 401 adds the storage set configuration information to a control packet. The control/route information addition unit 402 adds the control information indicating read control, and route information to a data block. The data transfer unit 403 transfers the control packet.

6) In each of the nodes B and G, the transfer packet building unit 404 reads a volume from a storage unit S based on the control packet, builds a transfer packet for transfer of the read data to the control device C of the node A, and outputs the packet to the data transfer unit 403. The data transfer unit 403 transfers the packet to the node A.

7) The packet analysis unit 7 of the node A obtains each of the volumes read from the storage units of the nodes B and G.

8) The parity calculation unit 603 computes the parity, and the data assembly unit 602 assembles the data before division from the three volumes based on the parity and the volume numbers. The packet building unit 601 generates a packet for transmission of the assembled data to a user who has issued a data read instruction.

Thus, the data is divided into a plurality of volumes, and each volume is stored in a plurality of storage units scattered through a network, thereby obtaining the following effects.

When a storage unit is stolen, the original data before the division cannot be reconstituted using the one volume stored in the stolen storage unit, thereby improving the security of the data.

Since the packet addressed to each node is only a part of the entire data, a packet capturing process in the network route cannot successfully reconstitute the original data before the division.

Since the storage units are scattered, the load can be distributed through a network. Therefore, when a backbone is configured at the same speed as the conventional technology, the time required for data access can be shortened. When the same response as the conventional technology is maintained, the bandwidth required for the backbone can be reduced.

Since the distribution and storage is simultaneously performed, the use efficiency of a storage unit can be better than using a backup center.

Described above is the process performed when data is reconstituted by reading all volumes configuring the data distributed and stored in a plurality of volumes. However, since data can be reconstituted without a redundant volume in a plurality of volumes, a volume excluding the redundant volume can be read from the storage unit of the plurality of nodes. To be more practical, when data is divided into three volumes in the redundant configuration of two pieces of data+1 parity bit, the two volumes out of the three volumes can reconstitute the original data. Therefore, the two volumes can be read from among the three volumes in the storage unit S to reconstitute the original data. In this case, the load on the network can be reduced.

When a volume excluding a redundant volume is read from the storage units S in a plurality of nodes, various combinations of read volumes can be set. Described below is the method of determining the optimum combination of volumes.

In this case, to determine the storage units to be read, the route evaluation information stored in the route evaluation table 507 in the control device C further includes the use priority of a section, and the storage evaluation information stored in the storage evaluation table 508 further includes a route evaluation value.

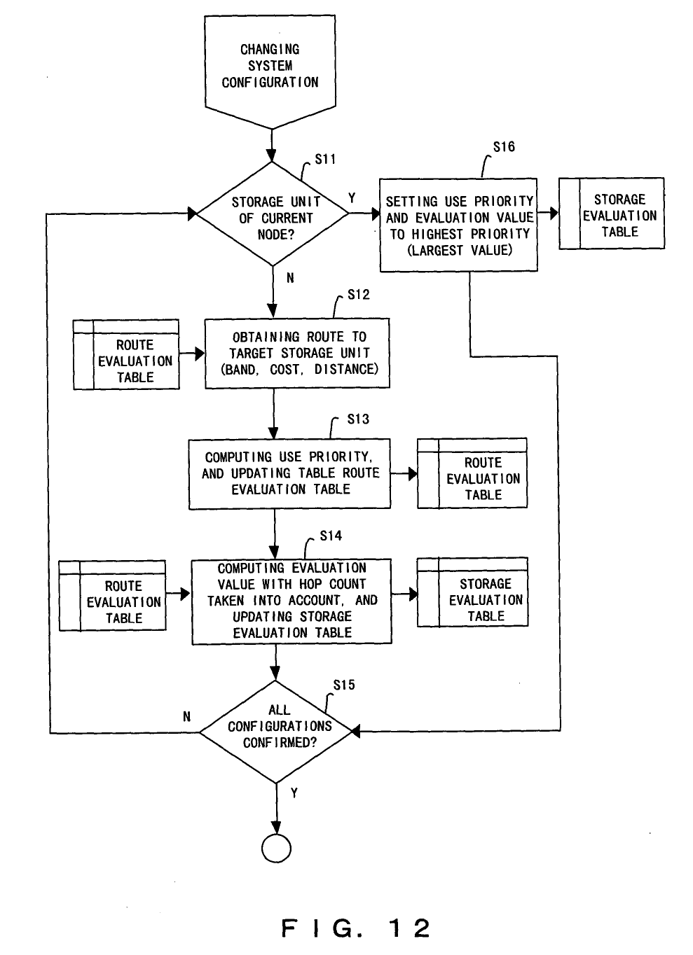

The procedure of the process of computing the use priority and evaluation value is described by referring to FIG. 12. The use priority (the use priority of a section and the use priority of a storage unit) and the evaluation value (a route evaluation value and a storage evaluation value) are computed for all nodes when a network configuration is changed, a line is disconnected, and the information stored in the route evaluation table 507 changes by adding or deleting a node.

As shown in FIG. 12, the route management unit 504 first retrieves a node as a computation target for a use priority and an evaluation value, and determines whether or not the node is a local node (own node) (S11). If the computation target node is not a local node (NO in S11), then control is passed to step S12. If the computation target node is a local node (YES in S11), then control is passed to step S16.

In S12, the route management unit 504 obtains from the route evaluation table 507 the bandwidth, cost, and distance of each section in a computation target node through another node adjacent to the target node. Furthermore, the route management unit 504 computes the use priority of the section and the use priority of the storage unit, and updates the route evaluation table 507 based on the computation result (S13). The method of computing the use priority of the section and the use priority of the storage unit has already been described above.

The route management unit 504 computes the route evaluation value and the storage evaluation value for each route from the computation target node to another node, and updates the storage evaluation table 508 based on the computation result (S14). Furthermore, the route management unit 504 determines whether or not the use priority and the evaluation value have been computed on all nodes (S15). If the computation is performed on all nodes (YES in S15), then the process terminates. In not, control is returned to step S11.

In S16, the route management unit 504 sets the use priority and the evaluation value to the maximum values (S16), and control is passed to step S15. Thus, by setting the use priority and the evaluation value to the maximum values, the storage unit S of the local node can be assigned the highest priority in reading and writing a volume.

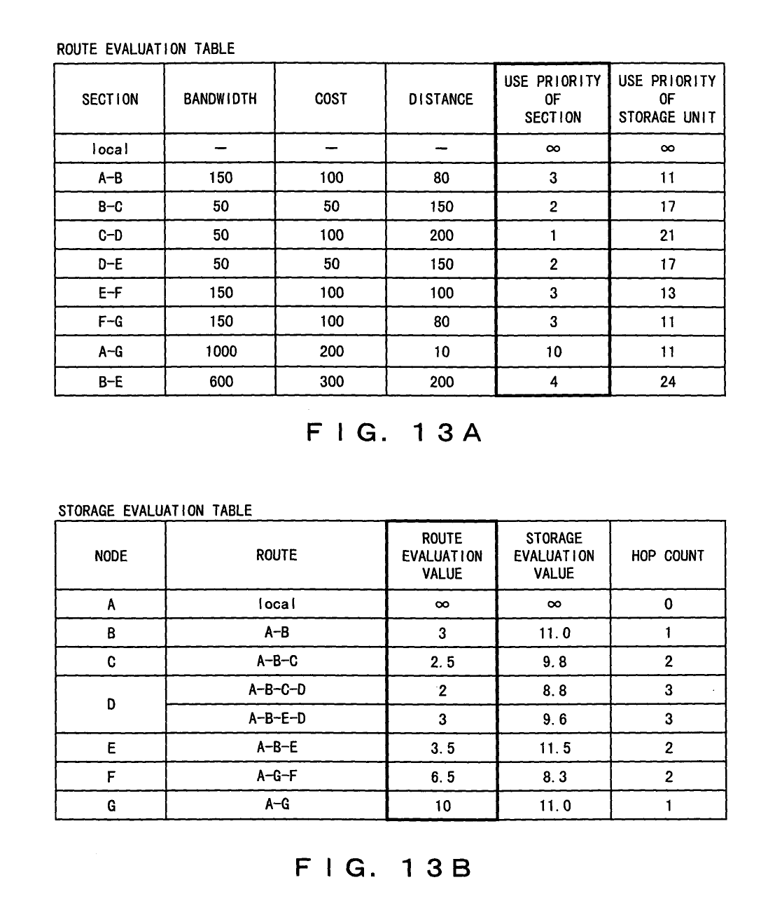

FIG. 13A shows an example of the route evaluation table 507 of the node A including the use priority of a section. FIG. 13B shows an example of the storage evaluation table 508 of the node A including the route evaluation value. The tables shown in FIGS. 13A and 13B can be recognized as tables of the node A because the node A is indicated as “local”. In the route evaluation table 507 shown in FIG. 13A, the use priority of a section is normalized based on the use priority of a section C-D as a reference.

The method of computing the route evaluation value is practically described below by referring to FIGS. 13A and 13B. First, the method of computing a route evaluation value is described below by referring to FIG. 13A. As shown in FIG. 13A, the use priorities of the sections A-B and B-C are 3 and 2 respectively. In this case, the route evaluation value of the route A-B-C can be computed as follows.

$$\begin{matrix}route evaluation value of route A \text{-} B \text{-} C = \\ \{ ( use priority of section A \text{-} B ) + \\ ( use priority of section B \text{-} C ) \} \div \\ ( hop count ) = ( 3 + 2 ) \div 2 = 2.5\end{matrix}$$

Therefore, in FIG. 13B, the value “2.5” is stored as a value of the route evaluation value of the route A-B-C.

When data is reconstituted, the route management unit 504 obtains the node name of the node provided with the storage unit S storing the volume of the data to be reconstituted from the storage set management table 509, and determines to read a volume in order from a storage unit S of a node having a larger route evaluation value in the storage evaluation table 508 among the nodes. For a read volume, it is not necessary to consider the security of storage. Therefore, it is reasonable to determine a storage unit from which a volume is to be read based on a route evaluation value for which a distance is not considered.

The method of determining a storage unit from which the route management unit 504 is to read a volume when three volumes are distributed and stored in the nodes A, B, and G is described below by referring to FIG. 13B. It is assumed that the reconstituted data is transmitted to the user who has accessed the node A.

As shown in FIG. 13B, the route evaluation values for the nodes A, B, and G are “the maximum value”, “3”, and “10” respectively. If there are two volumes presented out of the three volumes, then the data can be reconstituted. Therefore, in this case, the route management unit 504 in the control device C provided for the node A determines one volume each from the storage unit of the node A and the storage unit of the node G. Thus, the volumes can be read from the storage units with high response, and the data can be reconstituted.

When data is distributed and stored in the globally distributed storage system, the number of nodes can be often larger than the number of volumes. In this case, the node of the storage units S to store a volume can be selected. Described below is the method of determining the optimum storage set.

First described is the basic concept.

When a volume is stored in a storage unit distributed in a network, it is desired that a bandwidth, a cost, and a distance between nodes are considered. That is, it is desired that a circuit band is broad, the cost is low, and there is a long physical distance between nodes so that the system can recover earlier from a disaster. When nodes are close to each other, there can be the possibility that the nodes simultaneously become faulty from one disaster. Based on this concept, the use priority of a storage unit stored in the route evaluation table 507 and the storage evaluation value stored in the storage evaluation table 508 are defined such that the values can be larger with a wider circuit band, with a lower cost, and with a longer physical distance between nodes. The method of computing the storage use priority and the storage evaluation value has already been described.

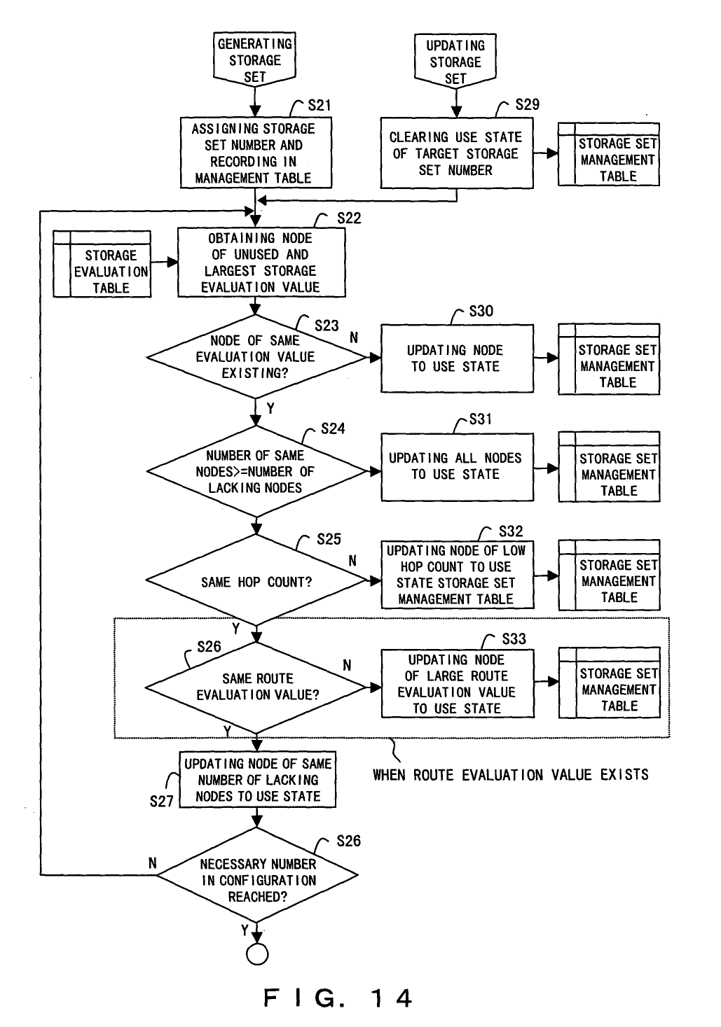

The process of determining a storage set storing volumes based on the storage evaluation value is described below by referring to FIG. 14. The process is performed on each use. In the following explanation, it is assumed that a route evaluation value is contained in the storage evaluation table 508 as an item.

When there is an instruction from a user to store new data, it is necessary to newly determine a storage set. A storage set refers to a node accessed by a user, that is, a storage set viewed from a local node. The number of nodes to be determined as a storage set is equal to the number of volumes obtained by dividing data.

To determine a storage set, the route management unit 504 of a local node assigns a storage set number, and stores the storage set configuration information in the storage set management table 509 (S21). At this time, only the storage set number is assigned to the storage set configuration information, and it is empty.

Then, the route management unit 504 refers to the storage evaluation table 508, and obtains the largest storage evaluation value and the node name of the node having the evaluation value from among the nodes which are not determined as the nodes configuring a storage set (S22).

The route management unit 504 determines (S23) whether or not it has obtained a plurality of nodes having the same storage evaluation values in S22. If it has obtained a plurality of nodes having the same storage evaluation values (YES in S23), then control is passed to step S24. If not (NO in S23), then control is passed to step S30.

In S24, the route management unit 504 determines whether or not the number of nodes having the same storage evaluation values is larger than the number of lacking nodes. If the number of nodes having the same storage evaluation values is larger than the number of lacking nodes (YES in S24), then control is passed to step S25. If not (NO in S24), then control is passed to step S31. The number of lacking nodes refers to the number obtained by subtracting the number of nodes determined as the nodes configuring the storage set from the number of nodes to be determined as the nodes configuring the storage set. That is, the number of lacking nodes refers to the number of nodes not yet determined in the total number of nodes to be determined as the nodes configuring the storage set.

In S25, the route management unit 504 determines whether or not the hop count is common among the plurality of nodes obtained in S22 from the local node to the current node. If the hop count is common (YES in S25), then control is passed to step S26. If not (NO in S25), then control is passed to step S32.

In S26, the route management unit 504 obtains the route evaluation value of the plurality of nodes obtained from the storage set management table 509 in S22, and determines whether or not a common route evaluation value is used for the nodes. If a common route evaluation value is used for the plurality of nodes (YES in S26), then control is passed to step S27. If not (NO in S26), then control is passed to step S33.

In S27, the route management unit 504 arbitrarily selects nodes equal in number to the lacking nodes from among the plurality of nodes obtained in S22, and determines the volumes to be stored in the storage units of each node. Then, the route management unit 504 writes the determined volume number in the field corresponding to each node in the storage set configuration information. At this time, the route management unit 504 also writes the flag (the original data in this case) indicating whether or not the volume is the original data, and the use state information (write enabled or read enabled). Thus, the nodes obtained in S22 are determined as the nodes configuring the storage set, and the state of the nodes is “in use”.

Then, the route management unit 504 determines whether or not the number of determined nodes is the necessary number required to configure the storage set (S28). If it is the necessary number of determined nodes (YES in S28), then the process terminates. If not (NO in S28), then control is returned to step S22.

In S30, the route management unit 504 determines the nodes obtained in S22 as the nodes configuring the storage set. The route management unit 504 determines the volume number of the volume to be written to the storage unit provided in the node as in S27, and writes the determination result, the flag indicating whether or not the volume is the original data, and the use state information to the storage set configuration information generated in S21. Then, control is passed to step S28.

In S31, the route management unit 504 determines the plurality of nodes obtained in S22 as the nodes configuring the storage set. As in S27, the route management unit 504 writes the determination result, the flag, and the use state information to the storage set configuration information generated in S21. Then, control is passed to step S28.

In S32, the route management unit 504 determines as the nodes configuring the storage set the nodes having a lower hop count in the plurality of nodes obtained in S22. As in S27, the route management unit 504 writes the determination result, the flag, and the use state information to the storage set configuration information. Then, control is passed to step S28.

In S33, the route management unit 504 determines as the nodes configuring the storage set the nodes having a larger route evaluation value in the plurality of nodes obtained in S22. As in S27, the route management unit 504 writes the determination result, the flag, and the use state information to the storage set configuration information. Then, control is passed to step S28.

As described above, the route management unit 504 determines the nodes configuring the storage set, and generates storage set configuration information. Based on the determination result, the plurality of volumes are distributed and stored in the storage units provided in the nodes determined as a storage set. The storage set configuration information is transmitted to the control device C of each node, and is stores in the storage set management table 509. If the route evaluation value is not contained in the storage evaluation table 508, then the processes in S26 and S33 are not performed in the above mentioned processes. The storage set can be updated when the network configuration is changed, etc. In this case, the route management unit 504 clears the use state information about the storage set configuration information relating to the storage set to be updated, and the processes in and after S22 are performed.

As described above, the control device C divides data into a plurality of volumes, and stores the volumes in the storage units selected based on the physical distance between the nodes. Thus, although a storage unit storing one of the volumes is destroyed by a disaster, the data can be reconstituted if the volumes stored in other storage units are safe. Therefore, if there is a sufficient physical distance between the nodes, there is no need to provide a backup center for the data.

The method of determining a storage set is practically described below by referring to the case in which redundant data in the configuration of three pieces of data+one parity bit is distributed and stored in a plurality of storage units. The user is assumed to access the node A.

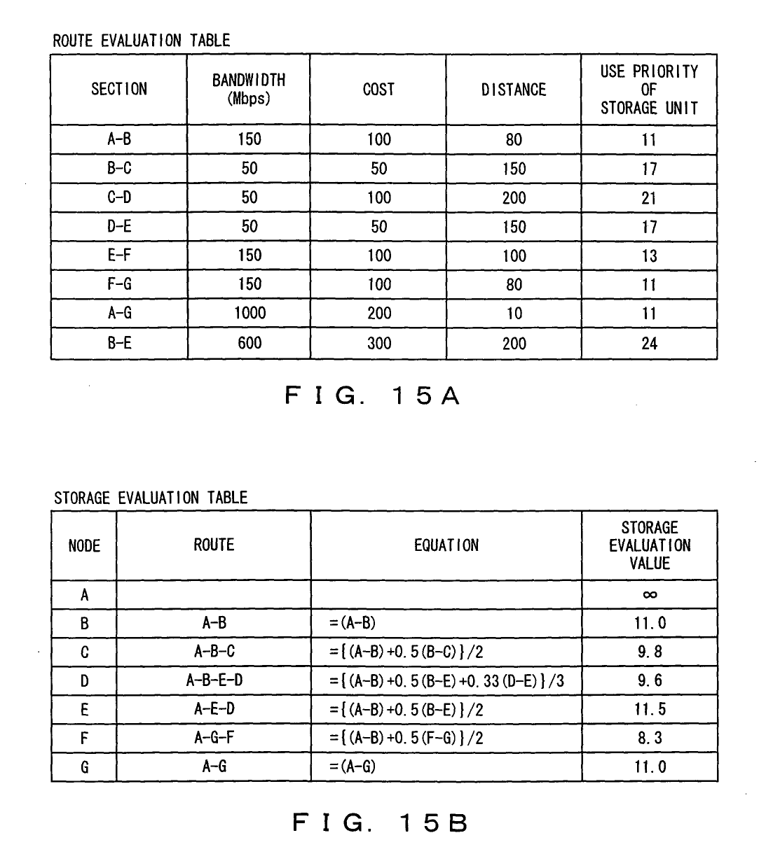

In this case, the data to be stored is divided into four volumes. Therefore, the route management unit 504 in the control device C provided for the node A determines four storage units for storing divided volumes based on the storage evaluation value stored in the storage evaluation table 508. FIG. 15A shows an example of the route evaluation table 507. FIG. 15B shows a storage evaluation value computed based on the data in the route evaluation table 507 shown in FIG. 15A.

The route management unit 504 is explained by referring to FIG. 15. That is, the route management unit 504 sequentially determines the four storage units in order from the storage unit of the node having the largest storage evaluation value, that is, the storage units of the nodes A, B, E, and G as the storage units for storing the volumes. The route management unit 504 generates the storage set configuration information based on the determination result.

As described above, each volume configuring the redundant and divided data is distributed and stored in the globally distributed storage system. Furthermore, it is obvious that a replica of each volume can be generated to be stored in a storage unit.

Described below is the case in which a user accessing a node other than the node recognized as a local node when a storage set is determined uses the data stored in the storage set.

In the following explanation, it is assumed that the user specifying the data storage, and gaining access when a storage set is determined is a user A, the node accessed by the user A is a node A, the new user using the data stored in the storage set is a user E, and the node accessed by the user E is a node E.

The user E can obtains data from the globally distributed storage system through the node E, but the above mentioned storage set is optimized for better use efficiency from the node A. Therefore, it is possible to generate a replica of a volume so that better use efficiency can also be obtained from the node E used by the new user E. The process is referred to as a user adding process.

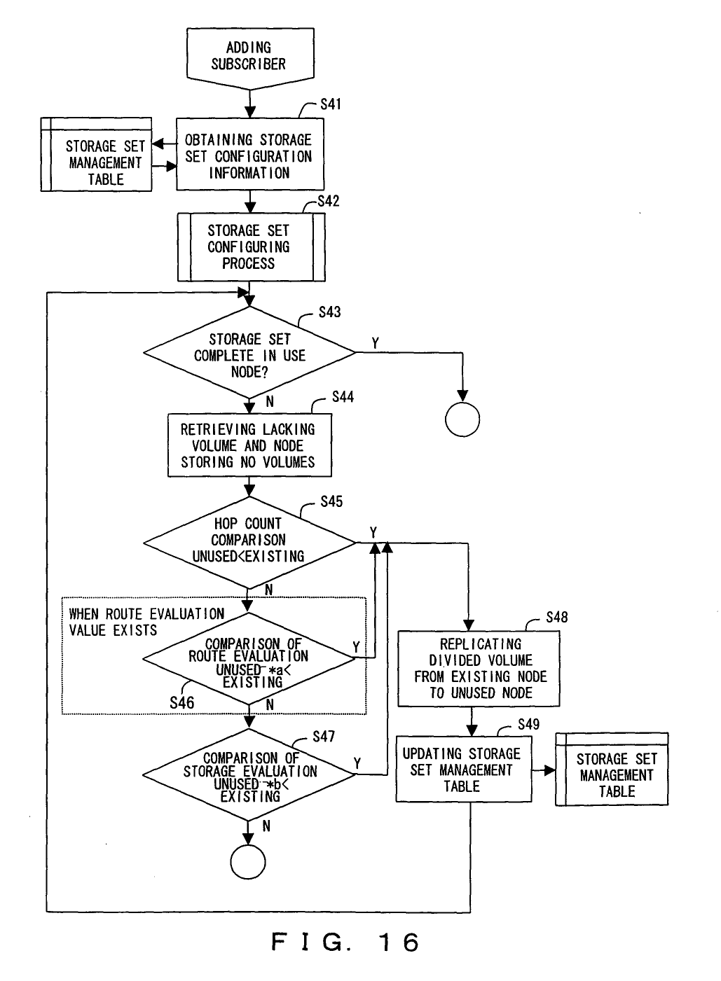

FIG. 16 shows the procedure of the process of adding a user using the storage set. The user adding process is described below by referring to FIG. 16. The following process is performed by the route management unit 504 of a node in which a user is added. In the following explanation, it is assumed that a route evaluation value is contained as an item in the storage evaluation table 508.

First, the route management unit 504 obtains a storage set number for specification of a storage set for which a user is added. The storage set number can be input when, for example, a user to be added gains access.

The route management unit 504 obtains the storage set configuration information corresponding to the storage set number from the storage set management table 509 (S41). Then, the route management unit 504 performs the process of determining a storage set (S42). This process is the same as the process described above by referring to FIG. 14.

The route management unit 504 determines whether or not all volumes configuring the data are stored in the node configuring the storage set determined in S42 according to the storage set configuration information obtained in S41 (S43). For example, when the data is divided into four volumes, four nodes are determined as a storage set in S42. The route management unit 504 determines whether or not four volumes have already been stored in these four nodes.

When the nodes configuring the storage set determined in S42 store all volumes configuring the data (YES in S43), the process terminates. In this case, better use efficiency can be obtained in the node used by the newly added user.

If the nodes configuring the storage set determined in S42 do not store all volumes configuring the data (NO in S43), the route management unit 504 obtains the node name of the node (hereinafter referred to as an unused node) not storing a volume in the nodes configuring the storage set determined in S42, and the node name of the node (hereinafter referred to as an existing node) storing a lacking volume (S44).

The route management unit 504 obtains the storage evaluation information about an unused node and an existing node from the storage evaluation table 508, and compares the hop count contained in each piece of storage evaluation information (S45). When the hop count of an unused node is smaller than the hop count of an existing node (YES in S45), control is passed to step S48. If not (NO in S45), then control is passed to step S46.

In S46, the route management unit 504 further compares the route evaluation value contained in each piece of storage evaluation information (S46). When the value obtained by multiplying the route evaluation value of an unused node by a constant a (1 or more) is smaller than the route evaluation value of an existing node (YES in S46), control is passed to step S48. Otherwise (NO in S46), control is passed to step S47.

In S47, the route management unit 504 further compares the storage evaluation value contained in each piece of storage evaluation information (S46). When the value obtained by multiplying the storage evaluation value of an unused node by a constant b (1 or more) is smaller than the storage evaluation value of an existing node (YES in S47), control is passed to step S48. Otherwise (NO in S47), the process terminates because better use efficiency can be obtained for an added user in the current state.

In S48, the route management unit 504 determines to replicate the lacking volume from a storage unit of the existing node, and write the replica to the stirage unit in the unused node. Based on the determination, the control packet generation unit 502 generates a control packet containing the storage set number, the volume number and the node name of the unused node, and whose control content is “replication of the volume”. Then, the control packet is transmitted from the control unit C to the existing node.

Subsequently, the route management unit 504 adds the volume number of the replicated volume, the flag indicating that the volume is a replica, and the use state information to the property of the unused node in the storage set structure information obtained in S41, thereby terminating the process. Thus, better use efficiency can also be obtained for an added user.

When a route evaluation value is not contained in the storage evaluation table 508, the process in S46 is not performed in the above mentioned process. The evaluation order can be changed depending on the configuration.

The user adding process is practically described below by referring to the case in which data is distributed and stored as four volumes in a plurality of storage units. In the explanation, it is assumed that the existing user A accesses the node A, and the added user E accesses the node E.

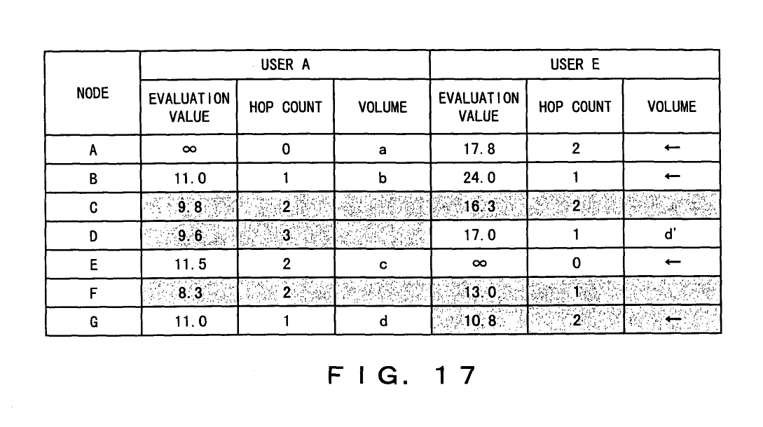

FIG. 17 shows a user adding process. In FIG. 17, a table indicating a storage evaluation value of each node, a hop count, and a volume stored in a storage unit of each node is shown as viewed from the node A in the left columns, and a table indicating them as viewed from the node E is shown in the right columns. In FIG. 17, the left-directing arrow indicates “the same as the left table”.

In FIG. 17, in the table as viewed from the node A in the left columns in FIG. 17, the four nodes A, B, E, and G having the highest storage evaluation values store the volumes a, b, c, and d respectively. Thus, the storage set is optimized such that the use efficiency can be appropriate for the node A. On the other hand, the four nodes having the highest storage evaluation values viewed from the node E of the added user E are A, B, D, and E. As described above, the nodes A, B, and E have already stored the volumes a, b, and c, but the node D has stored no volumes.

In this case, the node D is an unused node, and the node G is an existing node, and a volume d is a lacking volume.

In FIG. 17, the hop count from the node E to the node D is “1”, and the hop count from the node E to the node G is “2”. Therefore, the route management unit 504 of the node E generates a replica d′ of the volume d in the node E, and optimizes the storage set such that the appropriate use efficiency can be obtained as viewed from the node E.

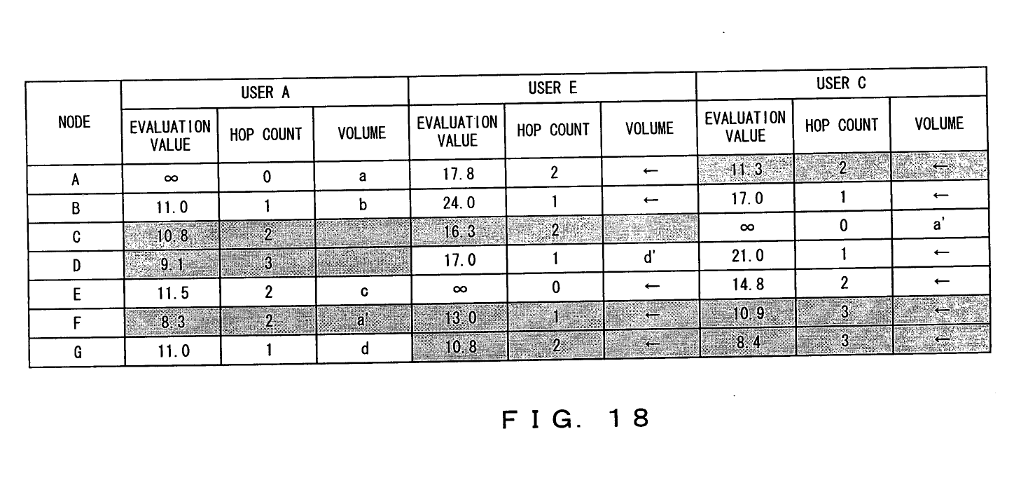

The user adding process is further described below. In the explanation of FIG. 17 above, the process of adding the user E using the node E is performed in the globally distributed storage system optimized such that the existing user A can access the node A. Then, the process of adding the user C using the node C as the third user is described below. FIG. 18 shows the process of adding the third user. In FIG. 18, a table indicating a storage evaluation value of each node, a hop count, and a volume stored in a storage unit of each node is shown as viewed from the node A in the left columns. In the central columns, a table indicating them as viewed from the node E is shown. A table indicating them as viewed from the node C is shown in the right columns. In FIG. 18, the left-directing arrow indicates “the same as the left table”. In this explanation, the data to be stored is assumed to be divided into four volumes.

When the third user is added, a process basically similar to the process described above by referring to FIG. 18 is performed. That is, the route management unit 504 obtains from the storage set management table 509 the storage set configuration information corresponding to the storage set number to which a user is to be added, and selects four nodes having the highest storage evaluation values contained in the storage set configuration information. In FIG. 18, the selected nodes are the nodes B, C, D, and E. These nodes are determined as the nodes configuring a storage set as viewed from the node C.

Then, the route management unit 504 determines whether or not all volumes configuring the data are stored in the node configuring the determined storage set. In FIG. 18, the volume b is written to the node B, the volume d′ (a replica of d) is written to the node D, and the volume c is written to the node E. However, the volume a is not written to any node configuring the determined storage set. The node C is an unused node. An existing node, that is, a node storing the volume a or a′ (a replica of a), is the nodes A and F.

In the case shown in FIG. 18, as a result of comparing the hop counts between the unused node and the existing node as viewed from the node C, the hop count of the existing nodes A and F (2 and 3 respectively) are larger than the hop count (0) of the unused node C. Therefore, the route management unit 504 copies the volume a from the existing node, and stores it in the unused node C.

Since there are two existing nodes A and F, there can be two copying methods as follows. Either of the methods can be adopted.

Method 1) A lacking volume is copied from a node having a low hop count and a high evaluation value, and stored in an unused node. In the case shown in FIG. 18, the volume a is copied from the node A.

Method 2) Two or more nodes are selected from among the existing nodes, a lacking volume in the selected nodes is distributed, read, copied, and stored in an unused node. In the case shown in FIG. 18, the volume c is distributed and read from the nodes A and F.

Described below is the method of confirming the state of each storage unit configuring the globally distributed storage system. It is also possible to configure the globally distributed storage system such that it can be constantly determined whether the state of each storage unit is normal or abnormal. In this case, the control device C of each node inquires of the storage unit of the local node about the state. In response to the inquiry, the storage unit issues a keep alive signal indicating the normal state. When the keep alive signal from the storage unit discontinues, the control device C of the node refers to the storage set management table 509, and designates a storage set configured by the node. Then, it notifies other nodes configuring the designated storage set of the occurrence of an abnormal state. The control device C which detects an abnormal state, and the control devices C which receive a notification of the abnormal state set the state information in the entire property in the storage set structure information to a value indicating an abnormal state (R (red)). Furthermore, all of the control devices C set “shutoff” of a write to the storage set. However, in response to a data read request from a user, each control device C continuously performs the process.

Described below is a temporary storage of written data and reconstituted data. The data for which a user specifies storage is divided into a plurality of volumes after being set as redundant data by a local node being accessed by the user, and transferred from the local node to each node configuring the storage set. At this time, the control device C of the local node can store the data corresponding to the storage set number of the data in the temporary storage area.

In this case, upon receipt of a data read request together with the storage set number from the user, the control device C of the local node determines whether or not the data corresponding to the storage set number is stored in the temporary storage area.

When the data is stored in the temporary storage area, the control device C transmits the data to the user. Otherwise, the control device C obtains from the storage set management table 509 the storage set structure information corresponding to the storage set number, obtains a necessary volume for reconstitution of the data from each node according to the storage set structure information, and transmits the data reconstituted using the volumes to the user. At this time, the reconstituted data is stored in the temporary storage area of the control device C. When the temporary storage area becomes full, the control device C deletes data of a low use frequency, and reuses the area used by the data, thereby improving the response when data is read.

Described below is the timing of writing data to a storage unit. Upon receipt of a data storage request, the control device C does not immediately divide the data into a plurality of volumes for distributed storage in the storage units of a plurality of nodes, but can temporarily store the data in the temporary storage area, and distribute and store the data in the storage units.

To be more practical, the control device C awaits the reception the data storage requests from the user at a predetermined frequency, and stores the data specified by the data storage request in the temporary storage area. When the data storage requests are received at a predetermined frequency, the control device C divides each piece of data stored in the temporary storage area into a plurality of volumes, stores one volume in a storage unit of a local node, transfers each of the other volumes to another node configuring the storage set, and stores the data in the storage unit of each node. Then, it deletes the data written to the temporary storage area. Thus, the frequency of transferring a volume to a node other than the local node can be reduced. Therefore, the traffic efficiency can be improved.

In the description above, the control device C stores data in a temporary storage area until data storage requests are received at a predetermined frequency. However, instead of awaiting the data storage requests at a predetermined frequency, a predetermined time and data can be stored in a temporary storage area. Also in this case, an effect similar to those described above can be obtained.

Described below is the process of updating a volume stored in the storage unit configuring the globally distributed storage system. As described above, data is divided into a plurality of volumes and stored in the storage units. When the data is updated, a multicast packet can be used. The process of the above mentioned case is described below.

1) First, the node configuring the storage set is grouped by volumes. For example, in the case of the storage set as shown on the table in FIG. 18, the storage set management unit 505 defines the nodes A, C, and F as a group of volume a, the node B as a group of the volume b, the node E as a group of the volume c, and the nodes D and G as a group of the volume d. The groups can be stored in the group table not shown in the attached drawings.

2) When the user updates each volume, a writing process is performed on a storage unit of a node in each of the groups of the volumes a, b, and d using the multicast packet from the local node used by the user.

3) Upon receipt of a notification of the normal completion of update from the node grouped by volumes, the storage set management unit 505 of the local node recognizes the completion of the update.

4) If an abnormal condition occurs when the updating process is performed, the storage set management unit 505 of the local node performs the updating process again on the volumes in the node in which the abnormal condition occurs.

Furthermore, when the data distributed and stored in the storage units is updated by a user, updating the original data or the replica of the volume configuring the data by other users can be prohibited. Thus, it is possible to control the contents of the original and the replicas of the updated data. The process in the above mentioned case is described below.

The outline of the procedure of the performed process is as follows.

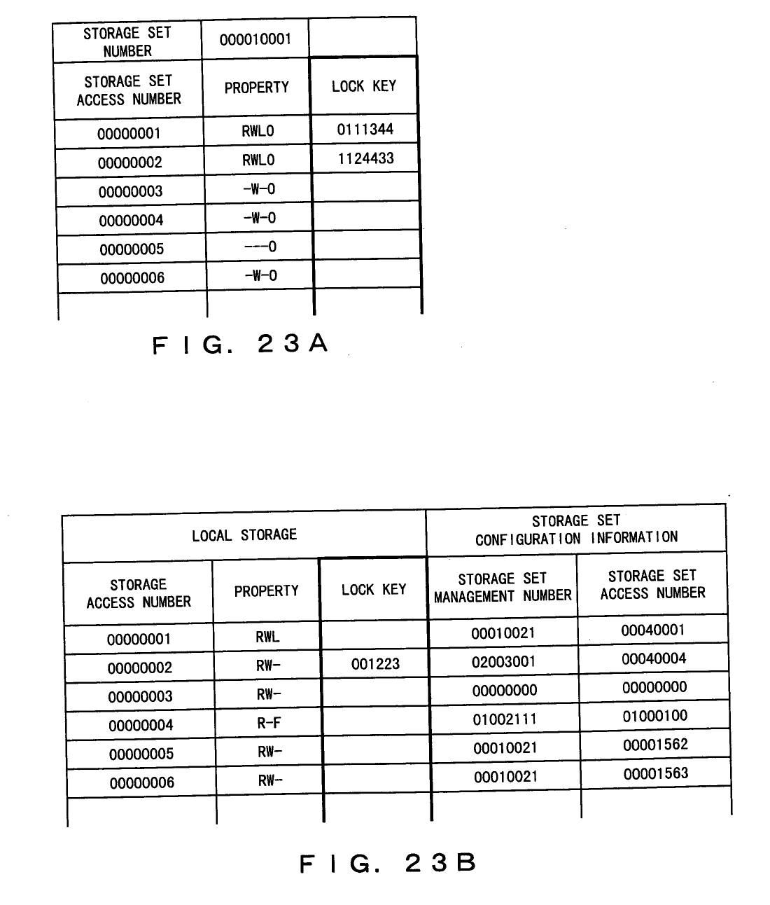

1) First, the user accesses the node, specifies the storage set number of the data to be updated, and transmits an update request to the node. Hereinafter, the node accessed by the user is referred to as a local node. The storage set management unit 505 in the control device C of the local node issues a lock key to the user. A lock key is used to identify the user requesting to update the user, and is unique for each user and session in the globally distributed storage system. FIG. 23 shows an example of the access management table 510 and the local volume management table 511 to which the functions of the lock key are added.

2) The storage set management unit 505 in the control device C of the local node prohibits updating by other users the volume designated by the storage set number (hereinafter referred to as a lock), and requests other nodes configuring the storage set to lock the corresponding volume.

3) The storage set management unit 505 in the control device C of each node which receives the request locks each volume.

4) The storage set management unit 505 in the control device C of the local node confirms that each volume is locked.

5) The control device C of the local node sets the data to be updated redundant, divides the data into a plurality of volumes, and transmits each volume to a node for storing it.

6) When the process of transmitting and updating the volume is completed, the storage set management unit 505 in the control device C of each node releases the lock.

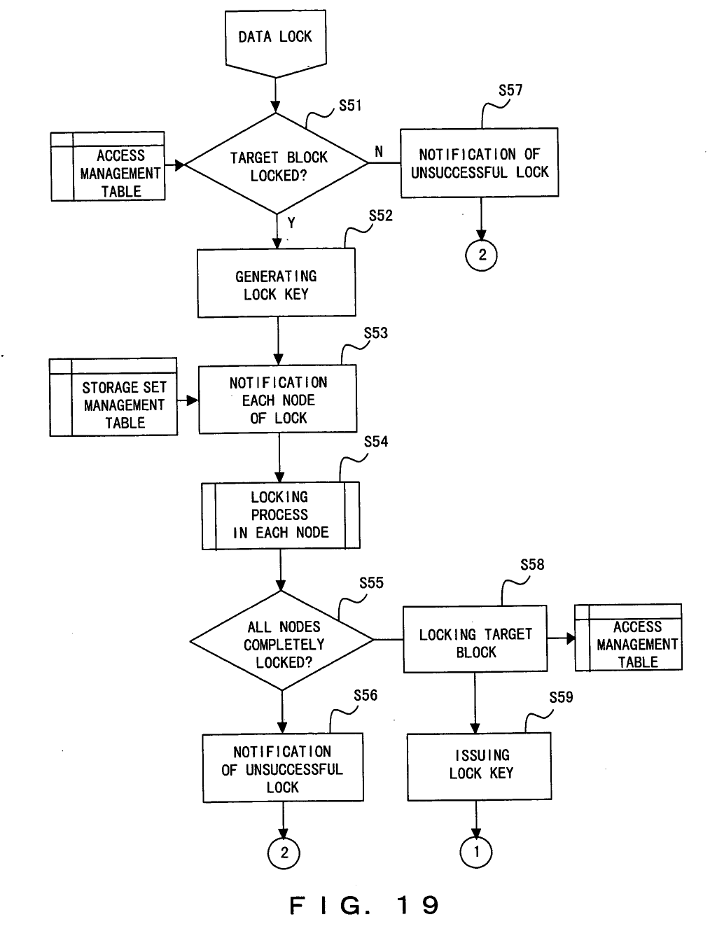

Described below in detail are the procedures 2) through 6). First, the procedure 2) is described in detail by referring to FIG. 19. The procedure shown in FIG. 19 is performed by the storage set management unit 505 in the control device C of the local node which receives the specification of the storage set number and an update request from the user.

First, the storage set management unit 505 obtains the access management information corresponding to the storage set number received from the user, and determines whether or not the state of the access unit (logical block) to which the update request is issued is a “locked state” according to the access management information (S51). If it is determined that the state of the access unit is a “locked state” (YES in S51), then control is passed to step S52. If the state of the access unit is anything but the “locked state”, then control is passed to step S57. In S57, the storage set management unit 505 notifies the user that the lock has failed, thereby terminating the process (termination pattern 2: abnormal termination). In the case of an abnormal termination, the updating process cannot be performed.

In S52, the storage set management unit 505 generates a lock key.

Then, the storage set management unit 505 obtains from the storage set management table 509 the storage set structure information about the storage set corresponding to the storage set number, and notifies the node configuring the storage set a request to lock the storage set (S53). A lock request contains a storage set number, a storage set access number, and a lock key. It is obvious that the node configuring a storage set may include a local node.

Each node receiving the notification performs the locking process (S54). The process is described later.

The storage set management unit 505 of the local node awaits notifications that the locking process has been performed from all nodes to which the notification has been issued in S53 (S55). If the notifications that the locking process has been completed have been received from all nodes (YES in S55), then control is passed to step S58. Otherwise, (NO in S55), control is passed to step S56.

In S56, the storage set management unit 505 notifies the user of the unsuccessful lock, thereby terminating the process (termination pattern 2: abnormal termination).

In S58, the storage set management unit 505 updates into the “locked state” the property contained in the access management information about the access unit for which the update request has been issued, and further updates the access management table 510 so that the lock key generated in S52 can be added (S58). Furthermore, the storage set management unit 505 issues a lock key to the user (S59), thereby terminating the process (termination pattern 1: normal termination).

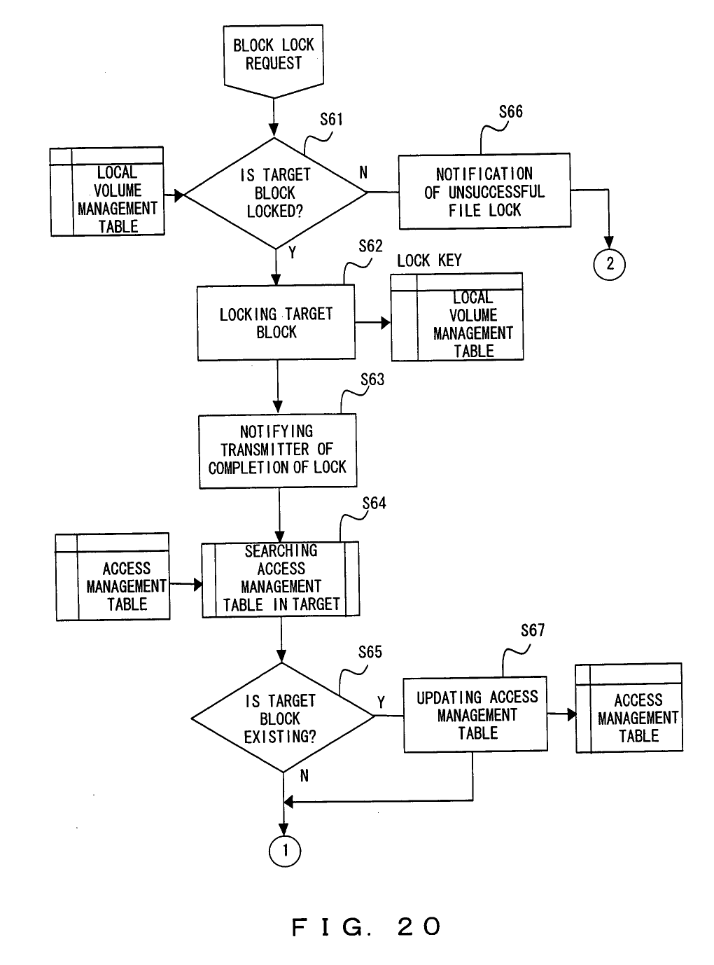

Then, the procedure 3) is explained by referring to FIG. 20. The procedure 3) corresponds to the process performed by the control device C of each node which receives the lock request in S54 shown in FIG. 19.

First, the local volume management unit 506 obtains from the local volume management table 511 the volume management information corresponding to the storage set number and the storage set access number received together with the lock request, and determines according to the volume management information whether or not the state of the access unit (logical block) in which the update request has been issued is the “locked state” (S61). If it is determined that the state of the access unit is the “locked state” (YES in S61), then control is passed to step S62. If the state of the access unit is not the “locked state”, then control is passed to step S66. In S66, the local volume management unit 506 notifies the user of the unsuccessful lock, thereby terminating the process (termination pattern 2: abnormal termination). In the case of abnormal termination; the updating process cannot be performed.

In S62, the local volume management unit 506 adds a flag indicating the “locked state” to the property contained in the volume management information about the access unit in which the update request has been issued, and adds the lock key. Then, the storage set management unit 505 notifies the control device C of the node which has issued the lock request of the completion of the lock (S63).

Furthermore, the storage set management unit 505 determines whether or not the access management table 510 stores the access management information about the logical block to be locked (S64). If the access management information is stored (YES in S65), then the storage set management unit 505 updates the property of the access management information into the “locked state”. If the access management information is not stored in the access management table 510 (NO in S65), then the process terminates (termination pattern 1: normal termination).

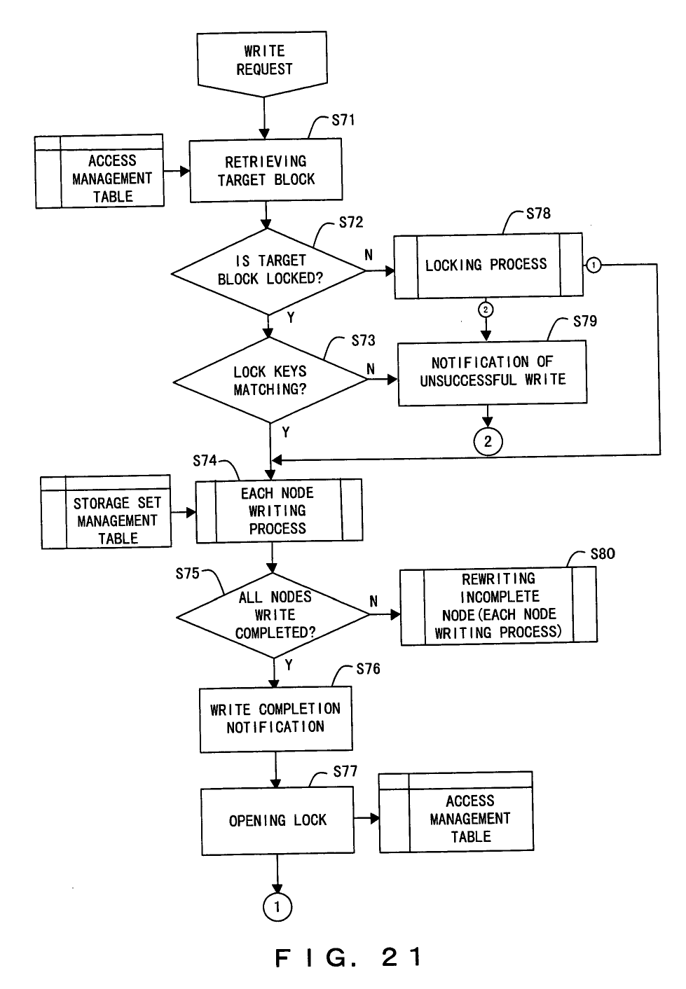

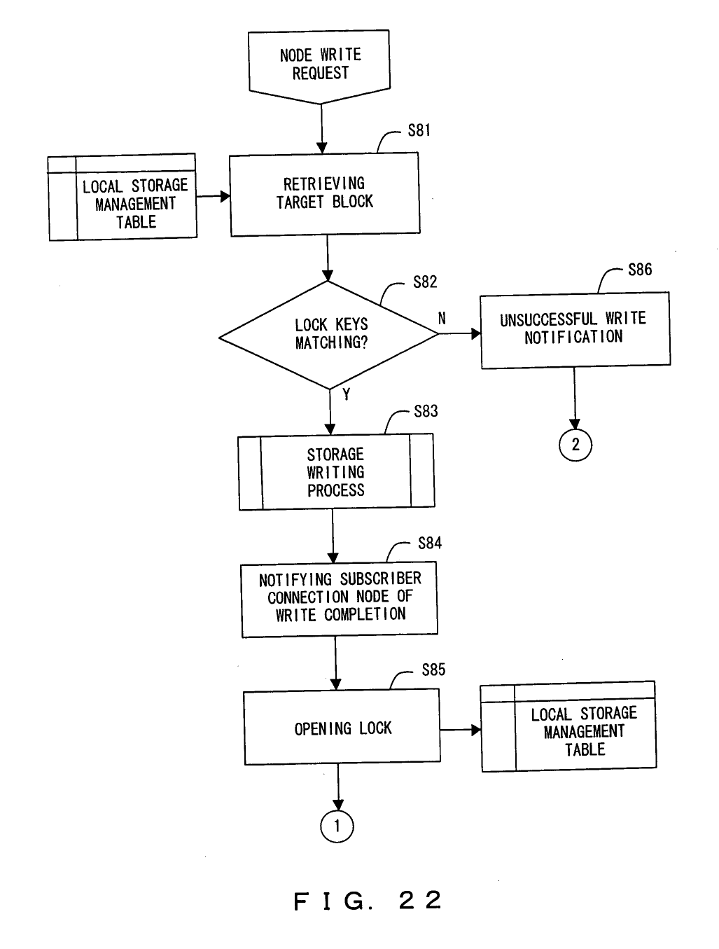

Then, the procedures 4) through 6) are described by referring to FIGS. 21 and 22. First, the user who has issued the update request transmits the contents of the data to be updated to a local node (not shown in the attached drawings). Next, the process shown in FIG. 21 is performed by the control device C of the local node.

The storage set management unit 505 of the local node obtains the access management information about the logical block to be updated (also a logical block to be locked) from the access management table 510 (S71). Then, the storage set management unit 505 determines whether or not a block to be updated is locked based on the property contained in the access management information obtained in S71 (S72). If the block to be updated is locked (YES in S72), then control is passed to step S73. If the block to be updated is not locked (NO in S72), then control is passed to step S78.

In S73, the storage set management unit 505 determines whether or not the lock key received from the user matches the lock key contained in the access management information. If the above mentioned two lock keys do not match each other (NO in S73), then the storage set management unit 505 notifies the user of the unsuccessful writing (updating) process (S79), thereby terminating the process (termination pattern 2: abnormal termination).

If the two lock keys match each other (YES in S73), then the data conversion unit 3 sets the data obtained from the user redundant, and divides the data into a plurality of volumes. Furthermore, the storage set control unit 501 obtains from the storage set management table 509 the storage set structure information about the storage set to be accessed. The route management unit 504 obtains from the storage set management table 509 the storage set structure information corresponding to the storage set number, and generates the control information and the route information so that a volume can be transmitted together with a write request to each node configuring the storage set according to the storage set structure information. The packet generation unit 4 transmits the packet assigned the control information and the route information to each node. A write request includes a storage set number, a storage set access number, and a lock key. In response to the write request, each node performs a process of writing data to the storage unit S (S74). This process is described later by referring to FIG. 22.

Then, the storage set management unit 505 awaits write completion notifications from all nodes to which the write request has been transmitted (S75). If the write completion notifications have not been received from all nodes (NO in S75), then the control device C of the local node retransmits volumes together with the write requests. In response to this, each node writes data again to the storage unit S (S80). This process is the same as that shown in S74.

If the write completion notifications have been received from all nodes (YES in S75), then the control device C transmits the write completion notifications to the users who have issued write requests (S76). The storage set management unit 505 obtains from the access management table 510 the access management information about the logical block to be updated, deletes the flag indicating the “locked state” from the property contained in the access management information (S77), thereby terminating the process (termination pattern 1: normal termination).

In S78, the control device C performs a locking process. Since the locking process has already been described above by referring to FIGS. 19 and 20, the explanation is omitted here. When the locking process in S78 normally terminates (termination pattern 1), control is passed to step S74. When the locking process in S78 abnormally terminates (termination pattern 2), control is passed to step S79.

The process shown in FIG. 22 is described below. The process shown in FIG. 22 corresponds to the process in S74 shown in FIG. 21, and is performed by the control device C of each node which receives the write requests.

First, the local volume management unit 506 obtains from the local volume management table 511 the volume management information corresponding to the storage set number and the storage set access number received together with the write request from the local volume management table 511 (S81). Then, the local volume management unit 506 determines whether or not the lock key contained in the volume management information matches the lock key contained in the write request (S82). If the two lock keys match each other (YES in S82), then control is passed to step S83. If not (NO in S82), then the local volume management unit 506 transmits a notification of an unsuccessful write to the control device C of the node which has transmitted the write request (termination pattern 2: abnormal termination)

In S83, the packet analysis unit 7 retrieves a volume from a packet received together with a write request, and writes the volume to the storage unit S through the storage IF 8. Then, the control packet generation unit 502 transmits a write completion notification to the control device C of the node which has transmitted the write request (S84). Then, the local volume management unit 506 deletes the flag indicating the “locked state” and the lock key from the property contained in the volume management information obtained in S81 (S85), thereby terminating the process.

Then, the case in which a multicast packet is used when data is updated in the above mentioned locking process is described below. The outline of the procedure of the process in this case is as follows. As in the case of the updating process using the above mentioned multicast, it is necessary to group by volumes the nodes configuring a storage set before the process. The control device C of each node is provided with a node group table (not shown in the attached drawings) indicating the nodes configuring the group of each volume and the representative node of the group.

1) In the storage set, a locking process is performed in a data access unit before updating data on the representative node (for example, a node storing original data).

2) The locking process is performed with the user who transmitted the update request recognizable by the nodes whose original data belongs to the same group (using a lock key). The procedures 1) and 2) above are the same as the above mentioned locking process.

3) The user who transmits the update request transmits the update contents of each volume using a multicast packet.

4) Each node which receives a packet containing the update contents confirms that the user who transmits a update request using a lock key matches the user who transmits the packet. If the confirmation can be made, the volume is updated.

5) When the updating process is performed in 4) above, the representative node of the group of the volumes transmits a packet indicating the completion of the update to the node being accessed by the user. A node other than the representative node transmits a packet indicating the completion of the update to the representative node of the group.

6) The representative node opens the lock to the volume stored in the current node. Upon receipt of a packet indicating the completion of the update from another node belonging to the current group, the representative node also opens the lock to the volume stored in the node.

7) When there is a node which has not transmitted a packet indicating the completion of the update in the nodes belonging to the current group, the representative node performs the updating process on the node.

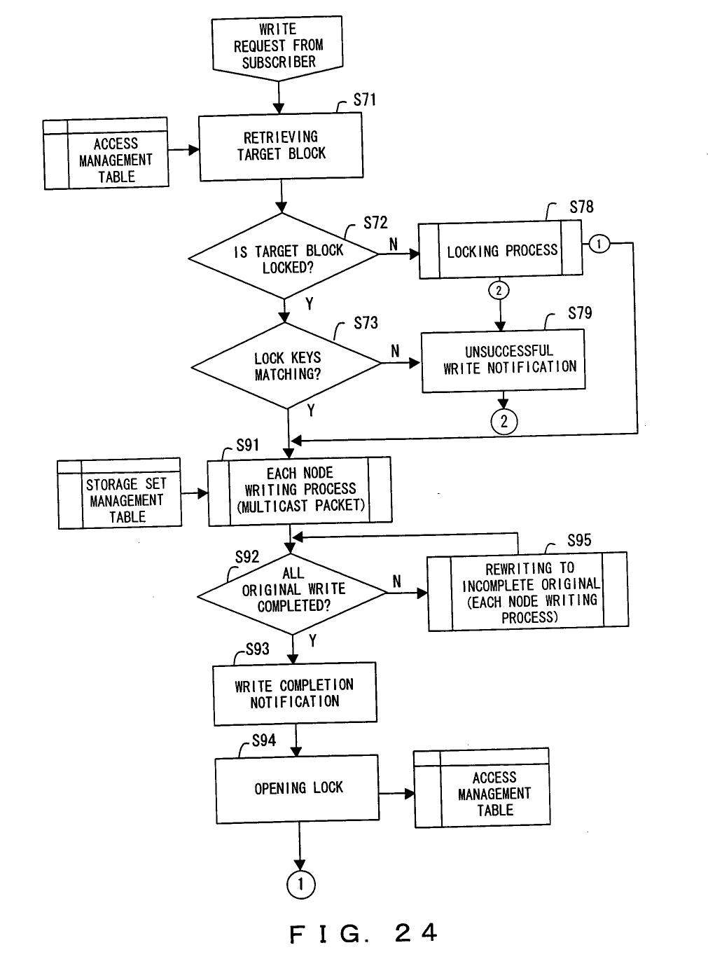

The procedures from 3) above are described below in detail by referring to FIGS. 24 through 26. Since the processes shown in FIGS. 24 through 26 include the procedures similar to those of the processes in FIGS. 21 and 22, the similar procedures are assigned the same reference numbers between FIGS. 21 and 22 and FIGS. 24 through 26, and the explanation is omitted here. First, the process performed in the node accessed by the user who issues an update request is explained by referring to FIG. 24. In the following explanation, the node accessed by a user is referred to as a local node.

In FIG. 24, the processes different from that shown in FIG. 21 are that the processes in S74 through S77 and S80 shown in FIG. 21 are replaced with the processes in S91 through S95. Described below are the processes in S91 through S95. The procedures in S91 through S95 correspond to the procedures performed by the control device C of the local node in the procedures described in 3) through 7) above.

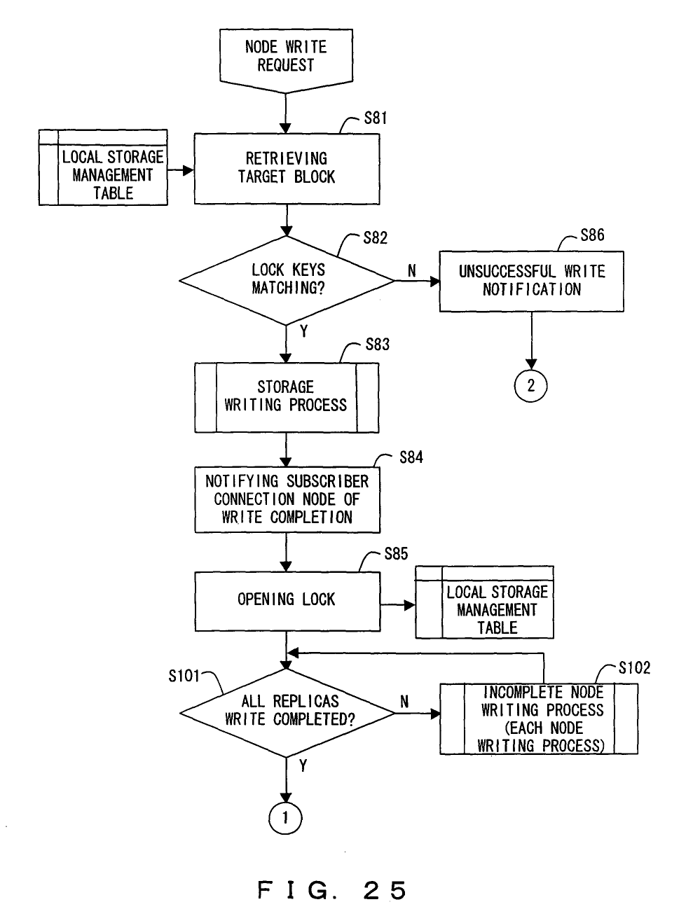

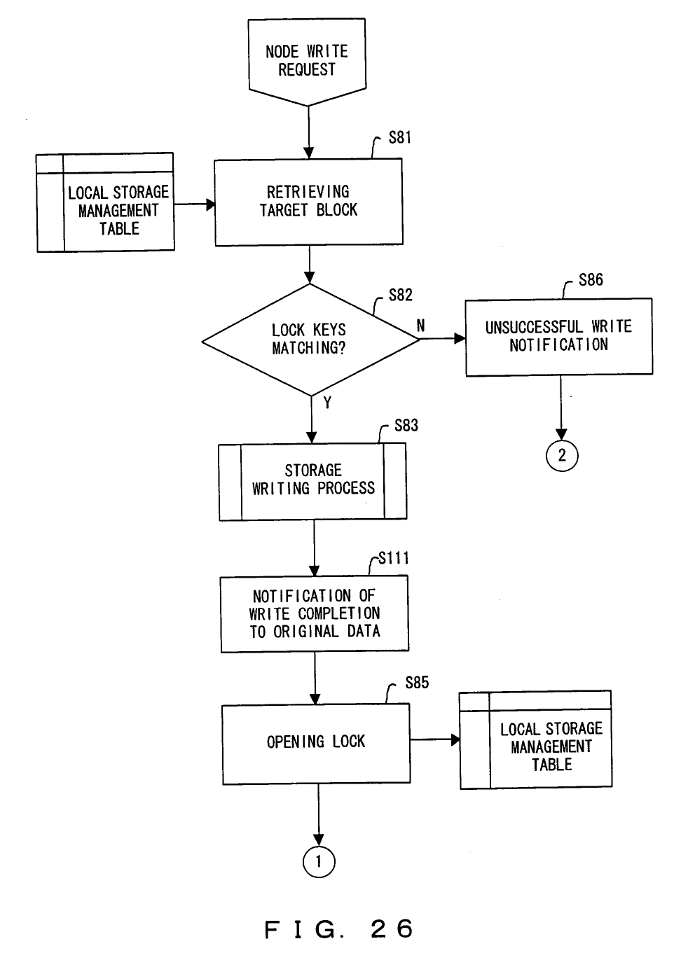

After the processes in S71 through S73, the route management unit 504 obtains from the storage set management table 509 the storage set structure information corresponding to the storage set number, and generates the control information and route information such that a volume to be written to a node can be transmitted together with a write request to the node configuring the storage set according to the obtained storage set structure information. The packet generation unit 4 transmits a packet provided with the control information and route information to each node in a multicast system. The write request contains a storage set number, a storage set access number, and a lock key. In response to the write request, each node writes a volume to the storage unit S (S91). The process is described later by referring to FIGS. 25 and 26.

Then, the storage set management unit 505 awaits the reception of a write completion notification from the representative node in the nodes to which the write request has been transmitted (S92). At this time, the storage set management unit 505 determines whether or not the write completion notifications have been received from all representative nodes based on the node group table not shown in the attached drawings. It is assumed that the nodes storing the original data in FIGS. 24 through 26 are the representative nodes.

If the write completion notifications have not been received from all representative nodes (NO in S92), then the control device C of the local node transmits to the representative nodes the volumes to be written together with the write request. In response to this, each node performs again the process of writing data to the storage unit S (S80). This process is the same as the process in S91.

When the write completion notifications are received from all nodes (YES in S92), the storage set management unit 505 of the local node notifies the user of the completion of the writing process (S93). Then, the storage set management unit 505 obtains from the access management table 510 the access management information about the logical block to be updated, and deletes the flag indicating the “locked state” from the property contained in the access management information, thereby terminating the process (termination pattern 1: normal termination) The control device C of the local node also performs the processes in S78 and S79. Since the processes in S78 and S79 are almost the same as the processes shown in FIG. 21, the explanation is omitted here.

The process performed in S91 shown in FIG. 24 is described below by referring to FIG. 25. The process in FIG. 25 is performed by the representative node in the group of each volume.

The process in FIG. 25 is different from that shown in FIG. 22 in that the processes in S101 and S102 are performed after S85 shown in FIG. 22. Described below are the processes in S101 and S102.

After the processes in S81 through S85, the storage set management unit 505 of the representative node awaits for the reception of the write completion notifications from all nodes in the group to which the representative node belongs (S101). The representative node makes a determination in S101 based on the node group table (not shown in the attached drawings). If the write completion notifications have not been received from all nodes (NO in S101), then the control device C of the representative node performs the writing process on the volume of the node which has not transmitted the write completion notification for the node (S102), thereby returning control to step S101.

When the write completion notifications have been received from all nodes (YES in S101), the process normally terminates (termination pattern 1).

Then, the process performed in S91 shown in FIG. 24 is described below by referring to FIG. 26. The process in FIG. 26 is performed by a node other than the representative node in the nodes configuring the storage set.

The process in FIG. 26 is different from the process shown in FIG. 22 in that the process in S111 is performed after S83 shown in FIG. 22 instead of the process in S84. Described below is the process in S111.

After the processes in S81 through S83, the storage set management unit 505 of the nodes other than the representative node transmit the write completion notification to the representative nodes of the groups to which the respective nodes belong (S111).

Described next is the generation procedure of a new volume. A new volume is generated, for example, when a volume is replicated, the system recovers from a fault, etc.

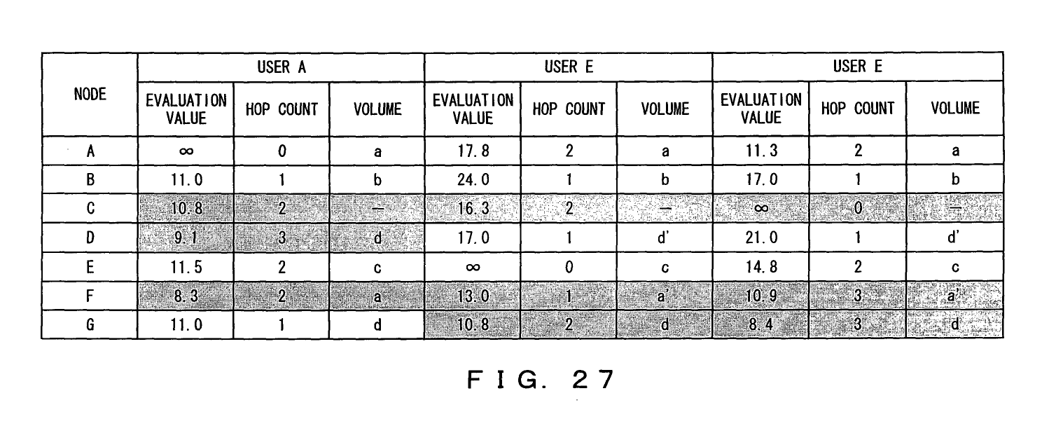

The procedure of generating a new volume is described below by referring to the case in which a volume is replicated. FIG. 27 is a table showing from left to right the storage evaluation values, the hop counts, and the volumes stored in the storage units of each node as viewed from each node when the user A accessing the node A, the user B accessing the node B, and the user accessing the node C use the globally distributed storage system. Determining the method of generating a replica is described below by referring to FIG. 27. In the explanation, it is assumed that the data is divided into four volumes.

In FIG. 27, the storage set to be used by the user C includes the nodes B, C, D, and E, and a replica of the volume is generated in the node C when the user C is added to the globally distributed storage system. The replica of the volume a can be generated in the following two methods.

1) Generating a replica from the volume a stored in either node A or F.

2) Regenerating a replica of the volume a in the redundant format from other volumes b, c, and d.

The storage evaluation values viewed from the node C of the node storing the volume from which a replica is generated and the node storing another volume are compared. When each of the largest storage evaluation values of the nodes storing other volumes exceeds the largest storage evaluation value of the node storing the volume from which a replica is generated, the method 2) above is selected. Otherwise, the method 1) above is selected.

For example, in the case shown in FIG. 27, the larger four storage evaluation values are listed bellow.

largest storage evaluation value of the node storing the volume a:

11.3 (node A)

largest storage evaluation value of the node storing the volume b:

17.0 (node B)

largest storage evaluation value of the node storing the volume c:

14.8 (node E)

largest storage evaluation value of the node storing the volume d:

21.8 (node D)

The storage evaluation value of the node A storing the volume a is lower than any of the storage evaluation values of the nodes storing other volumes. Therefore, in this case, the route management unit 504 of the node C determines that a replica of the volume a generated in the node C is regenerated using the redundant format of the volumes B, D, and C stored in the nodes B, D, and E. Based on the determination, the volumes b, c, and d are transferred from the respective nodes to the node C, and the packet analysis unit 7 of the node C regenerates the volume a from the received volumes b, c, and d, and writes the volume a to the storage unit S through the storage IF 8.

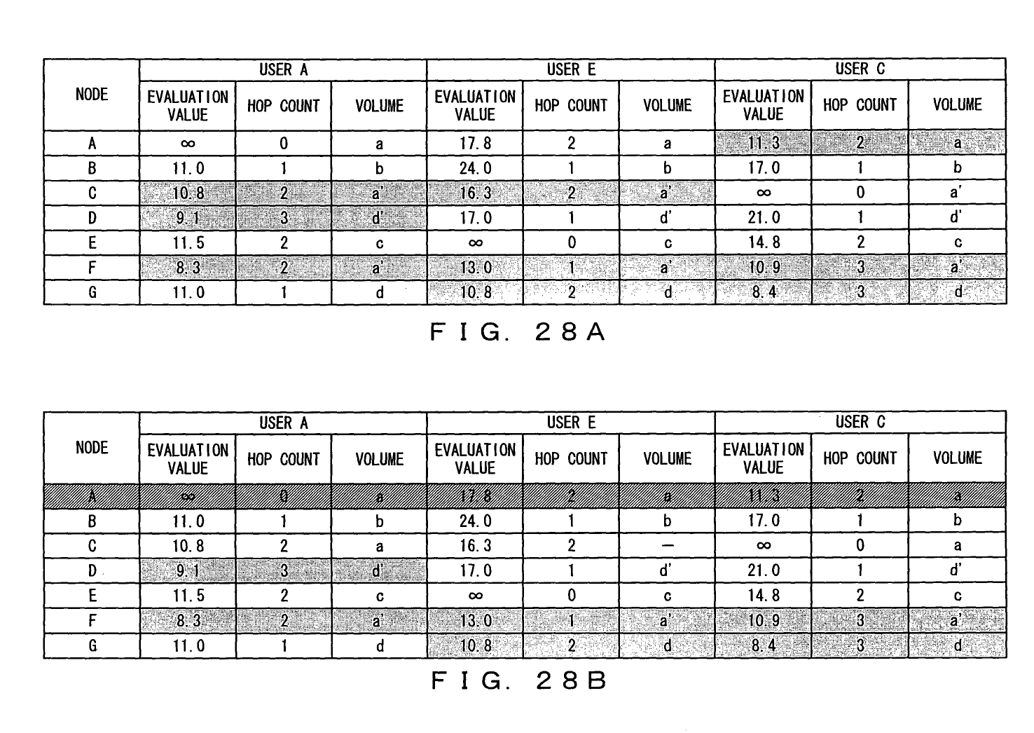

Described below is the process performed when a fault has occurred in a part of the node configuring the globally distributed storage system. First, the process of resetting the optimum storage set, when a fault occurs in a node, viewed from the other nodes is described below. In the explanation, it is assumed that data is divided into four volumes. It is also assumed that the state of each node after a fault has occurred is shown in FIGS. 28A and 28B. In FIGS. 28A and 28B, a table indicating a storage evaluation value of each node, a hop count, and a volume stored in a storage unit of each node is shown as viewed from the node A in the left columns. In the central columns, a table indicating them as viewed from the node E is shown. A table indicating them as viewed from the node C is shown in the right columns. In FIGS. 28A and 28B, the left-directing arrow indicates “the same as the left table”.

In the state as shown in FIG. 28A, the user A of the node A obtains the volumes a, b, c, and d from the nodes A, B, E, and G respectively. The user E of the node E obtains the volumes a, b, d′, and c from the nodes A, B, D, and E respectively. The user C of the node C obtains the volumes b, a′, d′, and c from the nodes B, C, D, and E respectively. The mark “′” indicates that the volume is a replica.

In the state above, when a fault occurs in the storage unit of the node A, the users A and E cannot obtain the volume a from the node A. In this case, since the volume a also exists in the nodes C and F, the storage set management units of the nodes A and E determine that the volume a is to be obtained from either node C or F instead of the node A.

The method of determining from which node the volume a is obtained is basically the same as the mothed of determining a storage set as follows.

1) A higher storage evaluation value is selected.

2) A lower hop count is selected when the storage evaluation values are equal.

In FIG. 28B, the storage evaluation values of the nodes C and F as viewed from the node A are “10.8” and “8.3” respectively. Therefore, the storage set management unit 505 of the node A determines to obtain the volume a from the storage unit of the node C instead of the storage unit of the node A. Similarly, the storage evaluation values of the nodes C and F as viewed from the node E are “16.3” and “13.0” respectively. Therefore, the storage set management unit 505 of the node E determines to obtain the volume a from the storage unit of the node C instead of the storage unit of the node A.

Furthermore, although the volume a stored in the storage unit of the node A in which a fault occurs is original data, the original data of the volume a does not exist as a result of the fault. Therefore, it is determined that either node C or F is used as a representative node. In FIG. 28B, as a result of the comparision of average value of the storage evaluation values of the nodes C and F in view of each node, the node C having a larger average value is used as the representative node.

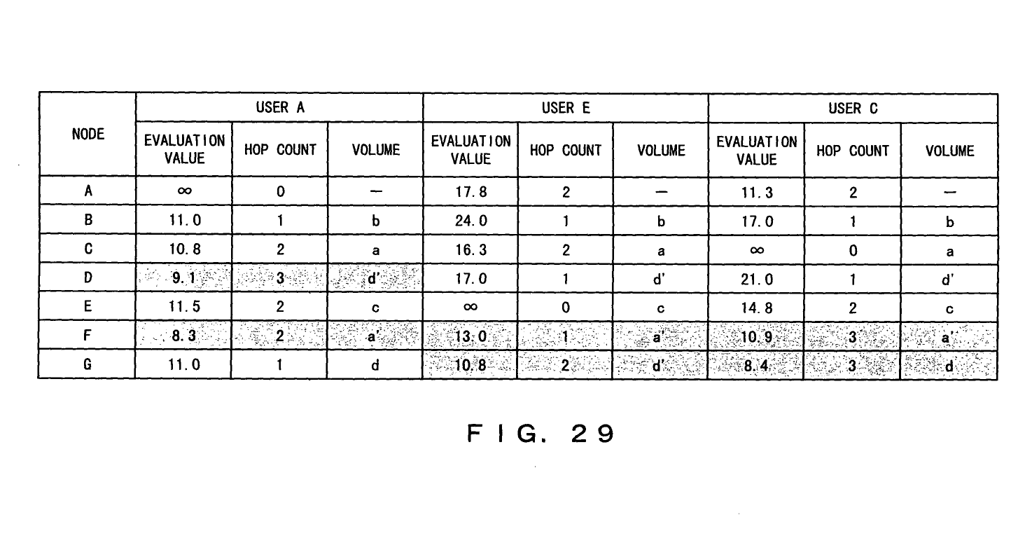

Described below is the procedure of generating a new volume when the system recovers from a fault. Like FIG. 28, FIG. 29 is a table showing from left to right the storage evaluation values, the hop counts, and the volumes stored in the storage units of each node as viewed from each node when the user A accessing the node A, the user E accessing the node E, and the user accessing the node C use the globally distributed storage system. The procedure of determining which volume is replicated when a volume is stored in the storage unit of the node A if the storage unit of the node A recovers from a fault is described by referring to FIG. 29. In this explanation, it is assumed that the data is also divided into four volumes.

1) First, the storage set management unit 505 determines whether or not the storage evaluation value of the recovery node is higher than the storage evaluation value of the node used before the recovery. If the storage evaluation value of the recovery node is higher than the storage evaluation value of the node used before the recovery, then the storage set management unit 505 determines to write a replica of the volume to the storage unit S of the recovery node. The replicated volume is a volume stored in the storage unit of the node having the lowest storage evaluation value.

For example, as shown in FIG. 29, in the node A, the storage units of the nodes B, C, E, and G are used before the recovery of the storage unit S of the node A. The storage evaluation value of the node A is higher than the values of them. The node having the lowest storage evaluation value in the nodes B, C, E, and G is the node C, and the volume stored in the storage unit S of the node C is volume a. Similarly, in the node E, the storage units of the nodes B, C, D, and E are used before the recovery of the storage unit S of the node A. Among them, the storage evaluation value of the node A is higher than the node C having the lowest storage evaluation value. In the node C, the storage evaluation value of the node storing the volume to be added before and after the recovery of the node A is not so high as to require a change of a node to be used. As a result, no specific process is required.

2) A replica is generated by the node having the highest storage evaluation value. Normally, it is generated by the node directly connected to the storage unit to which a replica of the volume is written. In the case shown in FIG. 29, the control device C of the node A (that is, the node connected to the storage unit in which a replica is generated) writes a replica of the volume a to the storage unit S of the node A.

3) When a replica is generated, the storage set management unit 505 of the node A compares the storage evaluation value of the node storing the volume to be replicated with the storage evaluation value of the node storing the volume. Based on the comparison result, a replica is generated based on the volume stored in the storage unit, or a volume is regenerated from another volume using a redundant format. Since the determining method is similar to the above mentioned method of generating a replica, the detailed explanation is omitted here.

In the case shown in FIG. 29, the node having the largest storage evaluation value in the nodes storing the volume a is the node C, and the value is 10.8. Since this value is lower than the storage evaluation value of the nodes storing other volumes, the storage set management unit 505 determines to regenerate a volume a using the redundancy from other volumes b, c, and d.

Described below is the management of a storage set. If nodes are added or deleted repeatedly, there are unused volumes, etc. In this case, it is possible to manage a storage set such that the use efficiency of storage units can be improved by deleting the unused volumes. Described below is the management of a storage set.

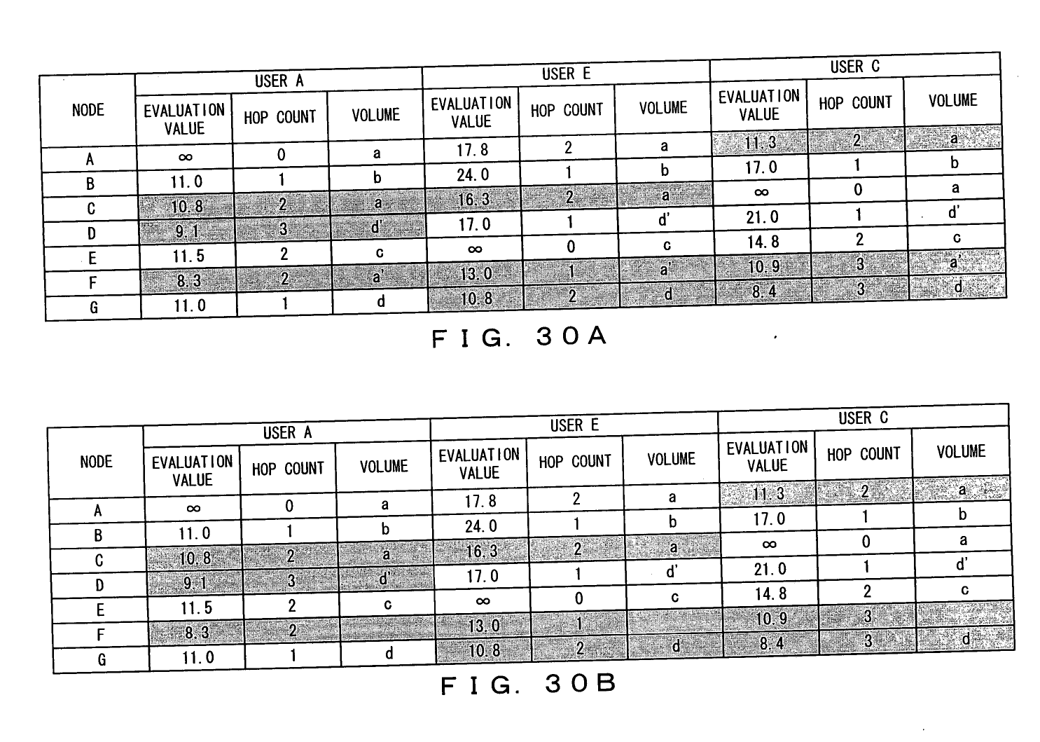

In the following explanation, it is assumed that the data is divided into four volumes, and is configured by the volumes as shown in FIG. 30 as a result of adding and deleting the nodes. Like FIG. 29, FIGS. 30A and 30B are tables showing from left to right the storage evaluation values, the hop counts, and the volumes stored in the storage units of each node as viewed from each node when the user A accessing the node A, the user E accessing the node E, and the user accessing the node C use the globally distributed storage system. FIG. 30A shows the state before deleting unused volumes, and 30B shows the state after deleting the unused volumes.

1) Each time a predetermined time passes, or each time the state of a volume stored in the storage unit S of each node is changed, the information about a storage set used in each node is switched in each node. Otherwise, the information is collected in an arbitrary node.

2) If there is a volume not used by any node according to the switched information, the storage set management unit 505 of one node determines that the volume of the node is to be deleted, and a control packet to instruct the node to delete the volume is transmitted to the node.

For example, in FIG. 30, the nodes used in a storage set in the node A is the nodes A, B, E, and G. The nodes used in a storage set in the node E is the nodes A, B, D, and E. The nodes used in a storage set in the node C is the nodes B, C, D, and E. (The used nodes are four nodes having the highest storage evaluation value). Therefore, it is clear that the node F has not been used by any users of the nodes. Therefore, the volume a′ stored in the storage unit S of the node F is deleted (FIG. 30B).

Described below is the process of sequentially generating a replica of data or regenerating the data. Replicating or regenerating data is performed when a user is added or a new node is added. These processes usually don't require to be performed urgently. In this case, replicating or regenerating data can be sequentially performed using idle time, etc. in the network. Thus, traffic can be efficiently used. The process performed in this case is described below. The process described below is performed by a node receiving a data read or write request from a user.

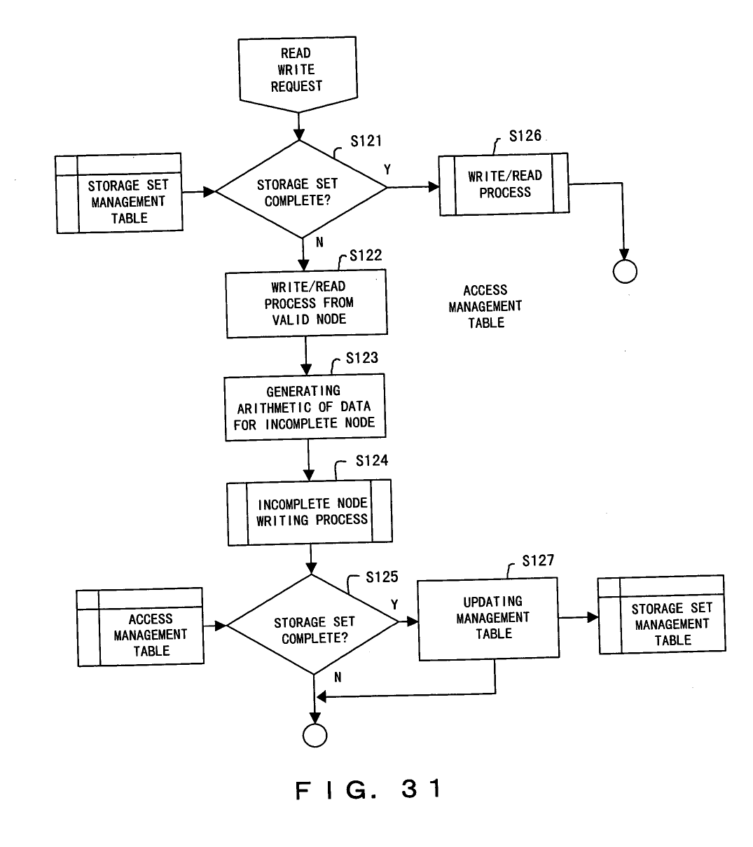

FIG. 31 is a flowchart of the process performed when data is sequentially replicated or regenerated. As shown in FIG. 31, the user first specifies the storage set number of the data to be read or written, and transmits a read request or a write request to the node to be accessed. The storage set management unit 505 of the local node obtains from the storage set management table 509 the storage set structure information corresponding to the storage set number, and determines whether or not all volumes configuring data have been stored in the storage set used by the local node according to the storage set structure information (S121)

When the storage set used by the local node stores all volumes configuring the data (YES in S121), the data read/write process is performed (S126). The read/write process is described above.

When the storage set used by the local node does not store all volumes configuring the data (NO in S121), the storage set management unit 505 generates requested data by redundancy from the volume obtained from each node when a read request is received. When a write request is received, the storage set management unit 505 sets the received data in a redundant format, divides the data into a plurality of volumes, and writes them to each node. At this time, the storage set management unit 505 obtains from the read or write access management table 510 the access management information having the corresponding storage set number, and assigns to the property relating to the access to the volume contained in the access management information a flag indicating whether the accessed data is complete data read from the storage unit S or generated data generated using the redundancy (S122).

When a read request is received from the user, the storage set management unit 505 designates a node storing no volumes (incomplete node) in the nodes configuring the storage set according to the storage set structure information obtained in S121, and generates the volume to be stored in the node from the volume read from another node configuring the storage set (S123).

The control device C of a local storage unit specifies a write of the generated volume, and transfers the volume to the storage unit S of the incomplete node. In response to the volume, the incomplete node performs the writing process on the volume (S124). The writing process is sequentially performed during the idle time of the network. The storage set management unit 505 assigns a flag indicating that the volume is not a complete data to the property about the incomplete node contained in the storage set structure information obtained in S121.

In the sequential writing process, a flag indicating whether the accessed data is complete data read from a storage unit S or generated data generated using the redundancy is assigned to the property in the access management information about the access in the writing process. When the writing process is completed, the flag indicating generated data is not assigned to the property in the access management information. In and after the second sequential writing process, the control device C of a local node can designate an incomplete node and a volume to be stored in the incomplete node based on the flag indicating the generated data in the storage set structure information and the access management information.

When the writing process is completed, the storage set management unit 505 refers to the access management table 510, and determines whether or not a flag indicating generated data is assigned to the access management information corresponding to the storage set number. If there is no access management information assigned the flag indicating generated data, then the storage set used by a local node stores all volumes configuring the data (YES in S125). In this case, the storage set management unit 505 of the local node removes the flag indicating no incomplete node from the property about the incomplete node contained in the storage set structure information (S127). When there is access management information assigned the flag indicating generated data, the sequential writing process has not been completed (NO in S125) In this case, the process temporarily terminates, and the process in S125 is repeated. The process in S125 can be repeated until the determination in S125 is “YES” or the process in S125 is repeated at a predetermined frequency.

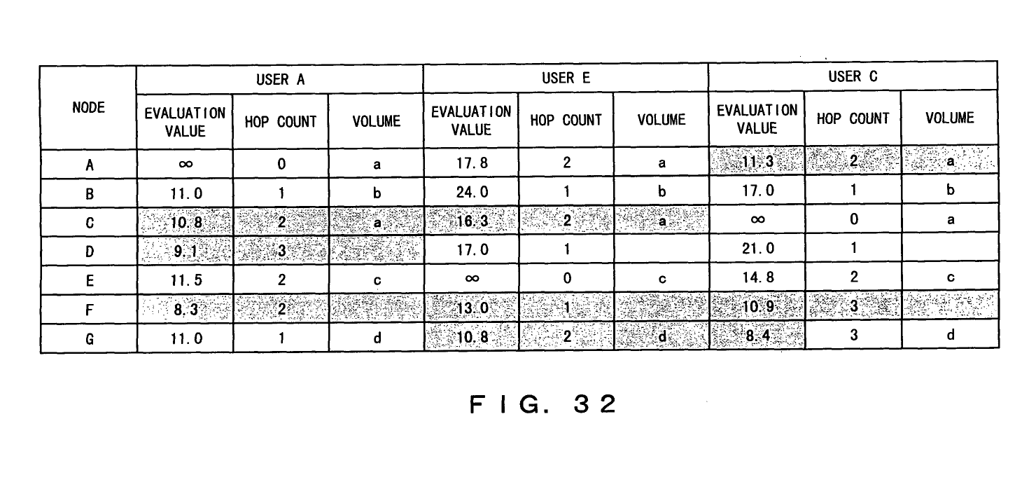

FIG. 32 is a table showing from left to right the storage evaluation values, the hop counts, and the volumes stored in the storage units of each node as viewed from each node when the user A accessing the node A, the user E accessing the node E, and the user accessing the node C use the globally distributed storage system. The case in which data is sequentially replicated or regenerated is practically explained by referring to FIG. 32. FIG. 32 shows the state when a user accessing the node C is added. In the following explanation, it is assumed that the data is divided into four volumes and stored. Additionally, in the following explanation, the node C accessed by the user C is referred to as a local node.

As shown in FIG. 32, the storage set used by the user C (that is, the storage set viewed from the node C) is the nodes B, C, D, and E. The nodes other than the node D have already stored volumes. The lacking volume is the volume d. However, since data can be reconstituted from the volumes b, a, and c stored in the nodes B, C, and E, it is unnecessary immediately to write the volume d to the node D.

Therefore, the storage set management unit 505 obtains the access management information having the corresponding storage set number from the access management table 510, and adds a flag indicating whether the data to be accessed is control device read from the storage unit S or generated data generated using the redundancy to the property relating to the access to the volume d in the access management information.

Upon receipt of a data read request from the user C, the control device C of the local node receives the volumes b, a, and c from the nodes B, C, and E, regenerates the data using the redundancy from the volumes, and transfers the data to the user. At this time, the control device C of the local node generates the volume c, and sequentially stores the volume d in the storage unit S of the node D.

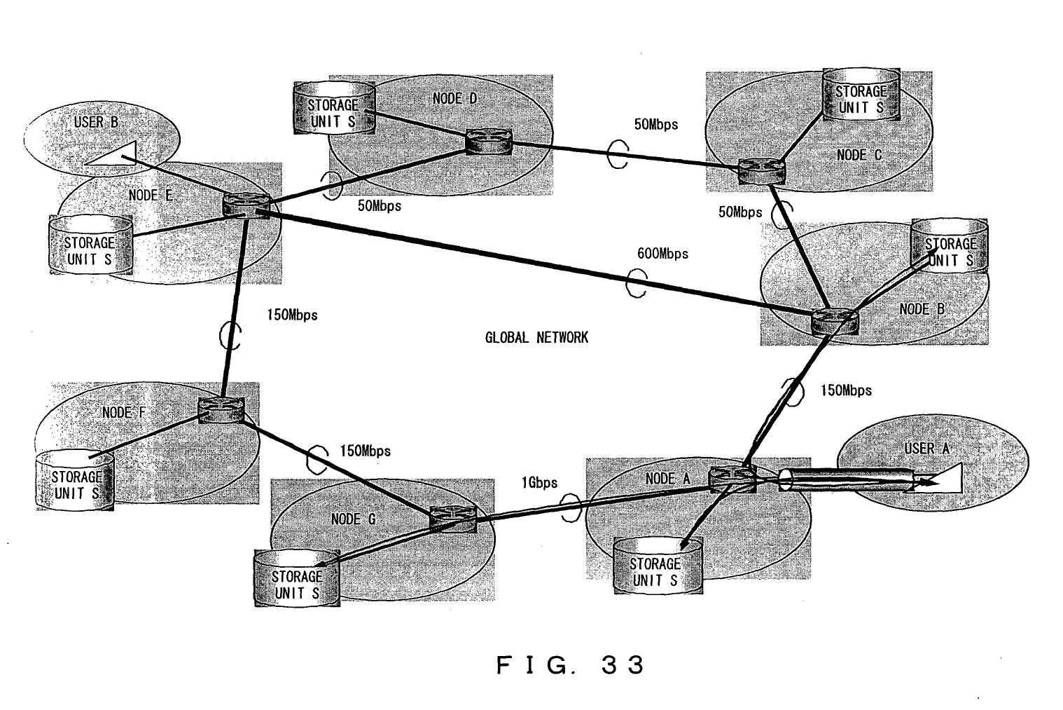

FIG. 33 shows an example of a variation of the method of arranging the control device. In the explanation above, the control device C is assumed to be provided in each node. However, the control device C can be provided in the terminal of a user. In this case, the terminal of a user divides data into a plurality of volumes, selects a storage unit for storing each volume, and writes the data to the unit. Furthermore, the terminal of the user reads the plurality of volumes from each storage unit, and reconstitutes the data. Also in this case, the effect similar to that obtained by the above mentioned globally distributed storage system can be obtained. FIG. 33 shows the case in which the terminal of the user A using the node A divides the data into three volumes, and stores them in the storage units S of the three nodes A, B, and G. In this case, the terminal of the user A reads three volumes from the nodes A, B, and G when reading data, and reconstitutes the data. Also in this case, there can be a number of variations corresponding to the above mentioned variations.

The control unit 5 in the control device C explained above can be configured using a computer. A computer comprises at least a CPU and memory connected to the CPU, and can also be provided with an external storage device, and a medium drive device. They are interconnected through a bus.

The memory can be, for example, ROM (read only memory), PAM (random access memory), etc., and stores a program and data used in processing. Each unit and table configuring the control unit 5 are stored as a program in a specific program code segment of the memory of the computer. The processes performed by the control device C are described by referring to the attached drawings.

The CPU performs a necessary process by executing the above mentioned program using the memory.

The external storage device is, for example, a magnetic disk device, an optical disk device, a magneto-optical disk device, etc. The external storage device realizes each table. Furthermore, the above mentioned program is stored in the external storage device to load them into the memory for use as necessary.

The medium drive device drives a portable storage medium, and accesses the contents stored on it. The portable storage medium can be a computer-readable storage medium such as a memory card, a memory stick, a floppy disk, CD-ROM (compact disc read only memory), an optical disk, a magneto-optic disk, a DVD (digital versatile disk), etc. The above mentioned program can be stored on the portable storage medium for use as necessary by loading it into the memory of the computer.

The above mentioned program can be downloaded through the network IF.

As described above in detail, data is set in a redundant format, and divided into a plurality of volumes according to the present invention with the data security improved by distributing and storing the volumes in a plurality of storage units, and with the bandwidth, the communications cost, and the physical distance between the node to which a write request is issued and the storage unit taken into account, thereby improving the line efficiency and the security of the data by selecting the optimum storage unit as viewed from the node.

While the invention has been described with reference to the preferred embodiments thereof, various modifications and changes may be made to those skilled in the art without departing from the true spirit and scope of the invention as defined by the claims thereof.

What is claimed is:

1. A method for storing data by a computer dividing redundant data into a plurality of volumes, distributing and storing the volumes in a plurality of scattered storage units through a network, comprising:
computing an evaluation value indicating desirability of each of the scattered storage units to be used based on a bandwidth, a communications cost, and a physical distance between a node to which a write request is issued and a storage unit; and
selecting a plurality of storage units as an optimum storage set from among the scattered storage units based on the evaluation value.

2. The method according to claim 1, wherein
in computing the evaluation value, a hop count from a node to which the write request is issued to each storage unit is further used.

3. The method according to claim 1, further comprising
providing the storage unit as a virtual storage unit for a user of the system.

4. The method according to claim 1, further comprising:
when the data is read from the storage set, reading from each storage unit volumes not containing a redundant portion among the plurality of volumes written to the storage set; and
reconstituting the data using the read volumes.

5. The method according to claim 3, further comprising:
when the data is read, computing a use priority indicating high response based on the bandwidth and the cost for each storage unit; and
determining which volumes among the plurality of volumes are to be read from each storage unit as volumes not containing a redundant portion based on the use priority.

6. The method according to claim 1, further comprising
storing a replica of a first volume in the plurality of volumes in a storage unit not selected as the storage set.

7. The method according to claim 6, further comprising
when a replica of the first volume is generated, based on the evaluation value selecting a method from between two generating method based on the evaluation value, that is, replicating the first volume from a storage unit storing the first volume, and regenerating the first volume using redundancy from volumes other than the first volume in the plurality of volumes.

8. The method according to claim 6, further comprising
selecting a storage unit storing a replica of the volume from among the storage units not selected as the storage set based on the evaluation value.

9. The method according to claim 6, further comprising
writing a volume in a multicast system to a plurality of storage units storing the same volume.

10. The method according to claim 6, wherein
when a replica of the first volume is written to a storage unit, a writing process is performed in plural operations.

11. The method according to claim 1, further comprising
when a fault occurs in the first storage unit in the storage set, limiting a write to other storage units in the storage set.

12. The method according to claim 1, further comprising
when a fault occurs in a third storage unit in the storage set, selecting based on the evaluation value a fourth storage unit other than a storage unit selected as the storage set instead of the third storage unit.

13. The method according to claim 1, further comprising:
after selecting the storage set, reselecting a storage set in each node at a predetermined timing; and
when there is a volume not used by any node as a result of reselection, deleting the volume from a storage unit.

14. The method according to claim 13, wherein
the predetermined timing refers to a predetermined period after previous selection or a timing of changing a state of a volume.

15. The method according to claim 1, further comprising:
after reading the data, temporarily storing the data for a predetermined period in an arbitrary storage unit; and
when data is read within the predetermined period, reading temporarily stored data from the storage unit.

16. A method according to claim 1, further comprising:
temporarily storing data specified in a write request within a predetermined period in a temporary storage area;
retrieving data from the temporary storage area after the predetermined period;
dividing the data into a plurality of volumes; and
writing the plurality of volumes in the storage set.

17. The method according to claim 15, further comprising
when a reading or writing process is performed on data including the temporarily stored data, reading or writing only a portion of data not containing the temporarily stored data.

18. The method according to claim 1, further comprising
when the plurality of volumes are written to the storage set, prohibiting a writing process on the storage set until a write is completed for a node to which the write request is issued.

19. The method according to claim 18, further comprising
determining a storage unit as a representative storage unit from among a plurality of storage units storing the same volumes, wherein:
in prohibiting a writing process in the plurality of storage units,
prohibiting a writing process to the representative storage unit is performed by a node to which the write request is issued; and
prohibiting a writing process to a storage unit other than the representative storage unit is performed by the representative storage unit.

20. The method according to claim 19, wherein
the representative storage unit is a storage unit for storing a volume as original data.

21. A computer-readable storage medium storing a program used to direct a computer to control processes of dividing redundant data into a plurality of volumes in a system comprising storage units scattered through a network, and distributing and storing volumes in a plurality of storage units, comprising:
computing an evaluation value indicating desirability of each of the scattered storage units to be used based on a bandwidth, a communications cost, and a physical distance between a node to which a write request is issued and a storage unit; and
selecting a plurality of storage units as an optimum storage set from among the scattered storage units based on the evaluation value.

22. A control device which controls dividing redundant data into a plurality of volumes in a system having scattered storage units through a network, and distributing and storing volumes in a plurality of storage units, comprising:
route management means for computing an evaluation value indicating desirability of each of the scattered storage units to be used based on a bandwidth, a communications cost, and a physical distance between a node to which a write request is issued and a storage unit; and
storage set management means for selecting a plurality of storage units as an optimum storage set from among the scattered storage units based on the evaluation value.

23. A control device which controls dividing redundant data into a plurality of volumes in a system having scattered storage units through a network, and distributing and storing volumes in a plurality of storage units, comprising:
a route management unit computing an evaluation value indicating desirability of each of the scattered storage units to be used based on a bandwidth, a communications cost, and a physical distance between a node to which a write request is issued and a storage unit; and
a storage set management unit selecting a plurality of storage units as an optimum storage set from among the scattered storage units based on the evaluation value.
